(19) United States
(12) Patent Application Publication
(10) Pub. No.: US 2008/0191864 A1
(43) Pub. Date: Aug. 14, 2008

(54) Interactive Surface and Display System

(76) Inventor: Ronen Wolfson, Raanana (IL)

Correspondence Address: BROWDY AND NEIMARK, P.L.L.C.;624 NINTH STREET, NW, SUITE 300, WASHINGTON, DC, 20001-5303, US

(21) Appl. No.: 11/910,417

(22) PCT Filed: Mar. 30, 2006
(86) PCT No.: PCT/IL2006/000408

§ 371 Date: Oct. 1, 2007

Related U.S. Application Data
(60) Provisional application No. 60/666,557, filed on Mar. 31, 2005.
(60) Provisional application No. 60/714,267, filed on Sep. 7, 2005.

(51) Int. Cl. G08B 23/00; G09B 7/00; A63F 11/00

(52) U.S. Cl. 340/524; 434/323; 482/92; 463/47

(57) ABSTRACT

An interactive training system capable of generating continuous feedback for physical therapy and training applications based on capturing and analyzing the movement of a user on an interactive surface. The training system captures sophisticated input such as the entire areas in contact with the interactive surface, center of gravity, pressure distribution, velocity, acceleration, direction, orientation etc. The training system also captures and/or calculates and/or estimates the position of a body part while in the air, not touching the interactive surface, and also while sensor input is unavailable. The training system can also provide alerts for predefined events such as a fall or the beginning of a fall.

### FIELD OF THE INVENTION

The present invention relates to an interactive display system wherein the content displayed on said system is generated based on the actions and movements of one or more users or objects. In particular, the present invention relates to means for generating content based on the position of one or more users or objects in contact with an interactive surface, and/or of the whole area of said one or more users or objects in contact with said interactive surface, to form an enhanced interactive display system.

### BACKGROUND OF THE INVENTION

Computerized systems currently use several non-exclusive means for receiving input from a user including, but not limited to: keyboard, mouse, joystick, voice-activated systems and touch screens. Touch screens present the advantage that the user can interact directly with the content displayed on the screen without using any auxiliary input systems such as a keyboard or a mouse. This is very practical for systems available for public or general use where the robustness of the system is very important, and where a mouse or a keyboard may breakdown or degrade and thus decrease the usefulness of the system.

Traditionally, touch-screen systems have been popular with simple applications such as Automated Teller Machines (ATM's) and informational systems in public places such as museums or libraries. Touch screens lend themselves also to more sophisticated entertainment applications and systems. One category of touch screens applications is designed for touch screens laid on the floor where a user can interact with the application by stepping on the touch screen. U.S. Pat. No. 6,227,968 and No. 6,695,694 describe entertainment systems wherein the user interacts with the application by stepping on the touch screen.

Current touch screen applications all detect user interaction by first predefining a plurality of predetermined zones on the screen and then by checking if a said predetermined zone has been touched by the user. Each predefined zone can either be touched or untouched. Present applications only detect the status of one predefined zone at a time and cannot handle simultaneous touching by multiple users. It is desirable that the system detect multiple contact points, so that several users can interact simultaneously. It is also desirable that the user may be able to interact with the system by using his feet and his hands and by using foreign objects such as a bat, a stick, a racquet, a toy, a ball, a vehicle, skates, a bicycle, wearable devices or assisting objects such as an orthopedic shoe, a glove, a shirt, a suit, a pair of pants, a prosthetic limb, a wheelchair, a walker, or a walking stick, all requiring simultaneous detection of all the contact points with the touch screen and/or an interactive surface communicating with a separate display system.

Other existing solutions of tracking a position or user interaction, either lack a display output or limit their inputs to a single defined zone of interaction at a time, lacking the ability to take into account simultaneous interaction with adjacent sensors as in U.S. Pat. No. 6,695,694 and No. 6,410,835. U.S. Pat. No. 6,762,752 and No. 6,462,657 supply only a partial solution to this problem, by forcing a sensor on the object being tracked, and lacking the ability to simultaneously detect all the contact points with the touch screen or interactive surface.

Another limitation of existing applications is that they do not take into account the entire area that is actually in touch with the screen. A more advanced system would be able to detect the whole area of a user or an object in contact with the touch-screen or interactive surface and so would be able to provide more sophisticated feedback and content to the user.

There is a need to overcome the above limitations not only for general interactive and entertainment needs, but also for advertising, sports and physical training (dancing, martial arts, military etc.), occupational and physical therapy and rehabilitation applications.

### SUMMARY OF THE INVENTION

The present invention relates to an interactive display system, wherein the content displayed on said system is generated based on the actions and movements of one or more users or objects, said system comprising:
i) an interactive surface, resistant to weight and shocks;
ii) means for detecting the position of said one or more users or objects in contact with said interactive surface;
iii) means for detecting the whole area of each said one or more users or objects in contact with said interactive surface; and
iv) means for generating content displayed on a display unit, an integrated display unit, interactive surface, monitor or television set, wherein said content is generated based on the position of one or more said users or objects in contact with said interactive surface and/or the whole area of one or more users or objects in contact with said interactive surface.

The interactive surface and display system of the present invention allow one or more users to interact with said system by contact with an interactive surface. The interactive surface is resistant to shocks and is built to sustain heavy weight such that users can walk, run, punch, or kick the screen and/or surface. The interactive surface can also be used in conjunction with different supporting objects worn, attached, held or controlled by a user such as a ball, a racquet, a bat, a toy, a robot, any vehicle including a remote controlled vehicle, or transportation aids using one or more wheels, any worn gear like a bracelet, a sleeve, a grip, a suit, a shoe, a glove, a ring, an orthopedic shoe, a prosthetic limb, a wheelchair, a walker, a walking stick, and the like.

The present invention detects the position of each user or object in contact with the interactive surface. The position is determined with high precision, within one centimeter or less. In some cases, when using the equilibrium of contact points, the precision is within five centimeters or less. The invention also detects the whole area of a user or object in contact with the interactive surface. For example, the action of a user touching an area with one finger is differentiated from the action of a user touching the same area with his entire hand. The interactive surface and display system then generates appropriate contents on a display or interactive surface that is based on the position of each user or object and/or on the whole area of said each user or object in contact with said interactive surface.

The generated content can be displayed on a separate display, on the interactive surface itself, or on both.

According to one aspect of the present invention, the system measures the extent of pressure applied against the interactive surface by each user, each user's contact area or each object. Again, the information regarding the extent of pressure applied is evaluated by the system together with their corresponding location for generating the appropriate content on the display screen.

The present invention can be used with a display system in a horizontal position, a vertical position or even wrapped around an object using any “flexible display” technology. The display system can thus be laid on the floor or on the table, be embedded into a table or any other furniture, be integrated as part of the floor, be put against a wall, be built into the wall, or wrapped around an object such as a sofa, a chair, a treadmill track or any other furniture or item. A combination of several display systems of the invention may itself form an object or an interactive display space such as a combination of walls and floors in a modular way, e.g. forming an interactive display room. Some of these display systems can optionally be interactive surfaces without display capabilities to the extent that the display system showing the suitable content has no embedded interactivity, i.e., is not any type of touch screen.

The display system can be placed indoors or outdoors. An aspect of the present invention is that it can be used as a stand-alone system or as an integrated system in a modular way. Several display systems can be joined together, by wired or wireless means, to form one integrated, larger size system. A user may purchase a first smaller interactive surface and display system for economical reasons, and then later on purchase an additional interactive surface to enjoy a larger interactive surface. The modularity of the system offers the users greater flexibility with usage of the system and also with the financial costs of the system. A user may add additional interactive surface units that each serve as a location identification unit only, or as a location identification unit integrated with display capabilities.

In another aspect of the present invention, a wrapping with special decorations, printings, patterns or images is applied on the interactive surface. The wrapping may be flat or 3-dimensional with relief variations. The wrapping can be either permanent or a removable wrapping that is easily changed. In addition to the ornamental value, the wrapping of the invention provides the user with a point of reference to locate himself in the interactive surface and space, and also defines special points and areas with predefined functions that can be configured and used by the application. Special points and areas on the wrapping can be used for starting, pausing or stopping a session, or for setting and selecting other options. The decorations, printings, patterns and images can serve as codes, image patterns and reference points for optical sensors and cameras or conductive means for electrical current or magnetic fields etc.

The optical sensors of the invention read the decorations, patterns, codes, shape of surface or images and the system can calculate the location on the interactive surface. Optical sensors or cameras located in a distance from the interactive surface can use the decorations, patterns, codes, shape of surface or images as reference points complementing, aiding and improving motion tracking and object detection of the users and/or objects in interaction with the interactive surface. For instance, when using a singular source of motion detection like a camera, the distance from the camera may be difficult to determine with precision.

A predetermined pattern, such as a grid of lines printed on the interactive surface, can aid the optical detection system in determining the distance of the user or object being tracked. When light conditions are difficult, the grid of lines can be replaced with reflecting lines or lines of lights. Lines of lights can be produced by any technology, for example: LEDs, OLEDS or EL.

When two or more systems are connected together, wrappings can be applied to all the interactive surfaces or only to selected units. The wrapping may be purchased separately from the interactive surface, and in later stages. The user can thus choose and replace the appearance of the interactive surface according to the application used and his esthetic preferences. In addition, the above wrappings can come as a set, grouped and attached together to be applied to the interactive surface. Thus, the user can browse through the wrappings by folding a wrapping to the side, and exposing the next wrapping.

In another aspect of the invention, the interactive surface of the display system is double-sided, so that both sides, top and bottom, can serve in a similar fashion. This is highly valuable in association with the wrappings of the invention. Wrappings can be easily alternated by flipping the interactive surface and exposing a different side for usage.

According to another aspect of the present invention, the system can be applied for multi-user applications. Several users can interact with the system simultaneously, each user either on separate systems, or all together on a single or integrated system. Separate interactive systems can also be situated apart in such a fashion that a network connects them and a server system calculates all inputs and broadcasts to each client (interactive system) the appropriate content to be experienced by the user. Therefore, a user or group of users can interact with the content situated in one room while another user or group of users can interact with the same content in a different room or location, all connected by a network and experiencing and participating in the same application.

There are no limitations on the number of systems that can be connected by a network or on the number of users participating. Each interactive system can make the user or users experience the content from their own perspective. When relevant, according to the application running, the content generated for a user in one location may be affected by the actions of other users in connected, remote system, all running the same application. For example, two users can interact with the same virtual tennis application while situated at different geographic locations (e.g. one in a flat in New York and the other in a house in London). The application shows the court as a rectangle with the tennis net shown as a horizontal line in the middle of the display. The interactive surface at each location maps the local user side of the court (half of the court). Each user sees the tennis court from his point of view, showing his virtual player image on the bottom half of the screen and his opponent, the remote user's image on the top half of the screen. The image symbolizing each user can be further enriched by showing an actual video image of each user, when the interactive system incorporates video capture and transmission means such as a camera, web-cam or a video conference system.

According to yet another aspect of the present invention, in a multi-user system using multiple interactive surfaces, the system can generate a single source of content, wherein each individual display system displays one portion of said single use of content.

According to still another aspect of the present invention, in a multi-user system using multiple interactive surfaces, the system can generate an individual source of content for each display system.

### BRIEF DESCRIPTION OF THE FIGURES

FIG. 1 illustrates a block diagram of an interactive surface and display system composed of an interactive surface, a multimedia computer and a control monitor.

FIG. 2 illustrates a block diagram of an interactive surface and display system composed of an integrated display system with connections to a computer, a monitor or television, a network and to a portable device like a smart phone or Personal Digital Assistant (PDA), a portable game console, and the like.

FIG. 3 illustrates a block diagram of the electronic components of the display system.

FIG. 4 illustrates the physical layers of an interactive surface.

FIGS. 5A-5B illustrate top and side views of a position identification system

FIG. 6 illustrates another side view of the position identification system

FIG. 7 illustrates the layout of touch sensors

FIG. 8 illustrates a pixel with position-identification sensors.

FIG. 9 illustrates the use of flexible display technologies.

FIG. 10 illustrates an interactive surface with an external video projector

FIG. 11 illustrates how a display pixel is arranged.

FIG. 12 illustrates a display system with side projection.

FIG. 13 illustrates a display system with integrated projection.

FIG. 14 illustrates an integrated display system.

FIGS. 15a-15g illustrate several wearable position identification technologies.

FIG. 16 illustrates use as an input device or an extended computer mouse.

FIGS. 17a-17d illustrate examples of how the feet position can be interpreted.

### DETAILED DESCRIPTION OF THE INVENTION

In the following detailed description of various embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention.

The following definitions are used herein:

Portable Device—Any portable device containing a computer and is mobile like a Mobile Phone, PDA, Hand Held, Portable PC, Smart Phone, Portable Game Console, and the like.

Parameter—sensors that measure input in a given domain. Examples of parameters include, but are not limited to: contact, pressure or weight, speed of touch, proximity, temperature, color, magnetic conductivity, electrical resistance, electrical capacity, saltiness, humidity, odor, movement (speed, acceleration, direction), or identity of the user or object. The maximum resolution of each parameter depends on the sensor and system, and may change from implementation to implementation.

Interactive Event—the interactive display system generates an event for an interactive input received for a given parameter at a given point in time and at a given point in space for a given user or object. The Interactive Event is passed on to the software application, and may influence the content generated by the system. Examples of Interactive Events can be a change in space, speed, pressure, temperature etc.

Compound Interactive Event—a combination of several Interactive Events can trigger the generation of a Compound Interactive Event. For example, changes in the position of the right and left feet of a user (2 Interactive Events) can generate a Compound Interactive Event of a change in the user's point of equilibrium.

Input—an Input operation according to a single scale or a combination of scales or according to predefined or learned patterns.

Binary Input—an input with predetermined ranges for a positive or negative operation. For example, pressure above a given limit of X will be considered as a legitimate validation (YES or NO).

Scalar Input—an input with a variable value wherein each given value (according to the resolution of the system) generates an Interactive Event.

Interactive Area—a plane, an area, or any portion of a fixed or mobile object including appropriate sensors to measure desired Parameters. An Interactive Area can identify more than one Parameter at the same time, and can also measure Parameters for different users or objects simultaneously.

Touching Area—a cluster of nearby points on a particular body part of a user, or on an object, forming a closed area in contact with, or in proximity to, an Interactive Area.

Contact Point—a closed area containing sensors that is in contact or within proximity of a Touching Area.

Point of Equilibrium—a pair of coordinates or a point on an Interactive Area that is deducted according to the area of the Contact Point. A different weight may be assigned to each point within the Contact Point, according to different Parameters taken into account. Only in cases where the position is relevant, the Point of Equilibrium is calculated according to the geometric shape. The system defines which parameter is taken into account when calculating the Point of Equilibrium, and how much weight is assigned to each Parameter. One of the natural parameters to use for calculating this point is using the pressure issued to the interactive area.

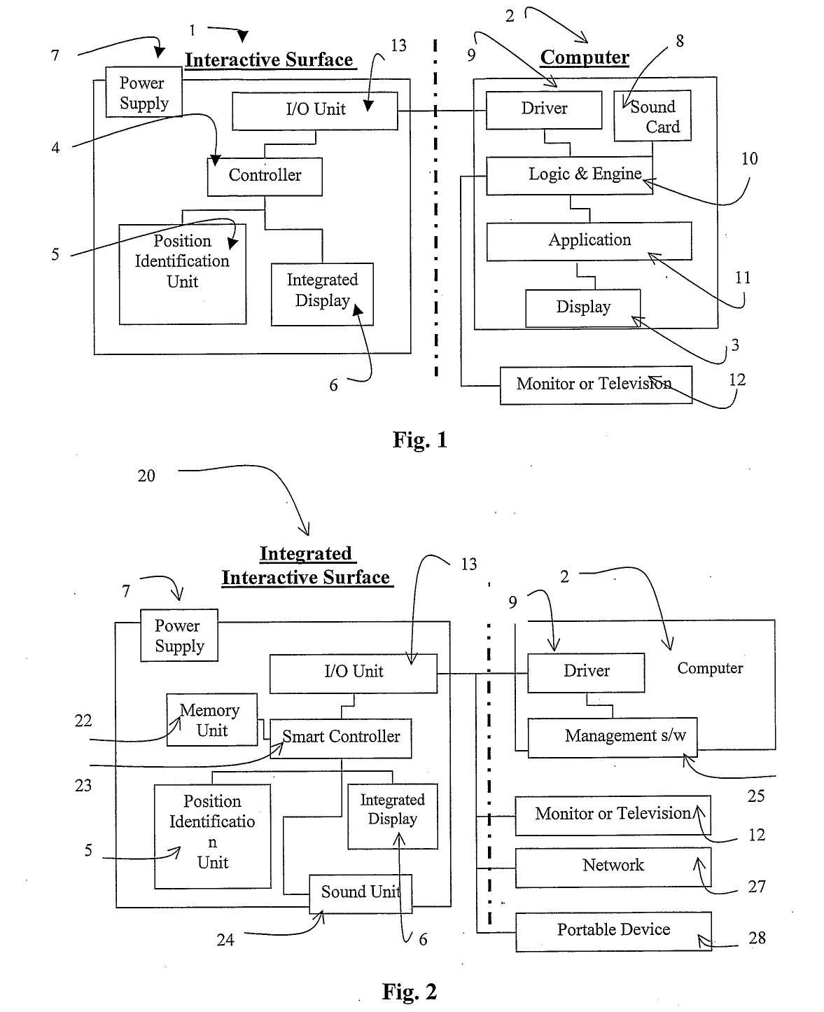

FIG. 1 shows an interactive surface and display system comprising two main units: an interactive surface 1 and a multimedia computer 2. In this preferred embodiment, the separate multimedia computer 2 is responsible for piloting the interactive surface unit 1. The interactive surface unit 1 is responsible for receiving input from one or more users or objects in touch with said interactive surface 1. If the interactive surface 1 has visualization capabilities then it can be used to also display the generated content on the integrated display 6. The interactive surface and display system can also be constructed wherein said interactive surface 1 only serves for receiving input from one or more users or objects, and the generated content is visualized on the multimedia computer's 2 display unit 3.

The multimedia computer 2 contains the software application 11 that analyzes input from one or more users or objects, and then generates appropriate content. The software is comprised of 3 layers:

The higher layer is the application 11 layer containing the logic and algorithms for the particular application 11 that interacts with the user of the system.

The intermediate software layer is the Logic and Engine 10 layer containing all the basic functions servicing the application 11 layer. These basic functions enable the application 11 layer to manage the display unit 3 and integrated display unit 6, position identification unit 5 and sound functions.

The most basic layer is the driver 9 that is responsible for communicating with all the elements of the interactive surface unit 1. The driver 9 contains all the algorithms for receiving input from the interactive surface unit 1 regarding the position of any user or object in contact with said interactive surface unit 1, and sending out the content to be displayed on said interactive surface unit 1 and display unit 6.

The multimedia computer 2 also includes a sound card 8 necessary for applications that use music or voice to enhance and complement the application 11. One or more external monitors 12 or television sets are used to display control information to the operator of the service, or to display additional information or guidance to the user of the application 11. In one aspect of the present invention, the external monitor 12 presents the user with pertinent data regarding the application 11 or provides help regarding how to interact with the specific application 11. In another aspect of the current invention, the interactive surface 1 serves only as the position identification unit 5, while the actual content of the application 11, beyond guidance information, is displayed on a separate screen like a Monitor or Television 12, or/and the screen in the portable device 28.

The interactive surface unit 1 is powered by a power supply 7. The input/output (I/O) unit 13 is responsible for sending and receiving data between the interactive surface unit 1 and the multimedia computer 2. The data transmission can occur via wired or wireless means. The display unit 6 is responsible for displaying content on the interactive surface unit 1. Content can be any combination of text, still images, animation, sound, voice, or video.

The position identification unit 5 is responsible for identifying all the contact points of any user or object touching the interactive surface unit 1. In one embodiment of the present invention, the position identification unit 5 also detects movements of any user or object performed between two touching points or areas. The present invention is particularly useful for detecting the entire surface area of any user or object in contact with the interactive surface unit 1.

If two or more users or objects are in contact with the interactive surface unit 1 at the same time then the position identification unit 5 detects their position simultaneously, including the entire surface area of any user or object in contact with the interactive surface unit 1.

In one embodiment of the present invention, the position identification unit 5 is a clear glass panel with a touch responsive surface. The touch sensor/panel is placed over an integrated display unit 6 so that the responsive area of the panel covers the viewable area of the video screen.

There are several different proximity and touch sensor technologies known in the industry today, which the present invention can use to implement the position identification unit 5, each technology using a different method to detect touch input, including but not limited to:
i) resistive touch-screen technology;
ii) capacitive touch-screen technology;
iii) surface acoustic wave touch-screen technology;
iv) infrared touch-screen technology;
v) a matrix of pressure sensors;
vi) near field imaging touch-screen technology;
vii) a matrix of optical detectors of a visible or invisible range;
viii) a matrix of proximity sensors with magnetic or electrical induction;
ix) a matrix of proximity sensors with magnetic and/or electrical induction wherein the users or objects carry identifying material with a magnetic and/or RF and/or RFID signature;
x) a matrix of proximity sensors with magnetic or electrical induction wherein users and/or objects carry identifying RFID tags;
xi) a system built with one or more optic sensors and/or cameras with image identification technology;
xii) a system built with one or more optic sensors and/or cameras with image identification technology in infra red range;
xiii) a system built with an ultra-sound detector wherein users and/or objects carry ultra-sound emitters;
xiv) a system built with RF identification technology;
xv) a system built with magnetic and/or electric field generators and/or inducers;
xvi) a system built with light sources such as laser, LED, EL, and the like;
xvii) a system built with reflectors;
xviii) a system built with sound generators;
xix) a system built with heat emitters; or
xx) any combination thereof.

The invention can use a combination of several identification technologies in order to increase the identification precision and augment the interactive capabilities of the system. The different technologies used for identifying the user's or object's position, can be embedded or integrated into the interactive surface unit 1, attached to the interactive surface unit 1, worn by the user, handled by the user, embedded or integrated into an object, mounted on or attached to an object, or any combination thereof.

Following are a few examples of combinations of several identification technologies that can be used according to the invention:
a. The user wears or handles any combination of special identification gear such as shoes, foot arrangements wrapped around each regular shoe, gloves, sleeves, pants, artificial limb, prosthetic, walking stick, walker, a ball etc. The specialized identification gear contains pressure sensors and one or more light sources emitting visible or infrared light to be detected or tracked by an optical motion tracking system connected to the system with suitable light frequency ranges. The optical motion tracking system can detect the position, velocity (optionally using also Doppler effect) and identification of each foot (which leg—right or left and user's identification) at each sampled moment. The information acquired from each arrangement (current sensors pressed and their corresponding amount of pressure) is sent either by modulating the light emitted like in a remote control device or using an RF transmitter.
b. As in example (a), but exchanging the light emitting technique with an acoustic transmitter sending from the used wearable or handled gear and received from two or more receivers. The information can be sent via IR or RF transmitters, with a suitable receiver at the base station.
c. As in example (a), but exchanging the light emitting technique with a magnetic field triangulation system or RF triangulation system. Each wearable or handled object as detailed example (a) incorporates a magnetic field sensor (with an RF transmitter) or RF sensor (with RF transmitter), while a base detector or a set of detectors are stationed in a covering range to detect the changes in magnetic or RF fields. The information can be sent via IR or RF transmitters, with a suitable receiver at the base station.
d. An interactive surface 1 with a matrix of pressure sensors detecting the location and amount of pressure of each contact points and area.
e. An interactive surface 1 with one or more embedded RFID sensors detecting the location of each contact area and the identification of the user or a part thereof or the object or part thereof touching or in proximity with the surface. The user or object wears or handles gear with an RFID transmitter. This can also be swapped, where the RFID transmitters are embedded in the interactive surface 1 and the RFID receivers are embedded in the handles or wearable gear.
f. Any of the examples a-e above further enriched with motion tracking means (optical or other) for detecting the movements and position of other parts of user's body or objects (worn or handled by the user) not touching the interactive surface 1. This enables the system to detect motion in space of body parts or objects between touching stages, so that the nature of motion in space is also tracked. This also enables tracking parts which did not yet touch the interactive surface 1 and may not touch in future, but supplement the knowledge about motion and posture of the users and objects in the space near the interactive surface 1. For example, a user's legs are tracked during touching the interactive surface 1, while when in air are tracked with the motion tracking system. The rest of the body of the user is also tracked although not touching the interactive surface 1 (knees, hands, elbows, hip, back and head).
g. Any of the above examples a-f, with base station detectors and motion tracking means embedded in the interactive surface 1 on different sides and positions. A typical arrangement is embedding them on different sides and comers of the frame of the interactive surface 1 or mounting points attached to the interactive surface 1.
h. Any of the above examples (a) to (f) with base station detectors and motion tracking means covering from a distance the interactive surface 1.
i. A combination of examples (g) and (h).
j. Any of the above examples a-i, further comprising a video camera or cameras connected to the computer 20, said camera or cameras used to capture and/or convey the user's image and behavior while interacting with the system.

The integrated display unit 6 is responsible for displaying any combination of text, still images, animation or video. The sound card 8 is responsible for outputting voice or music when requested by the application 11.

The controller 4 is responsible for synchronizing the operations of all the elements of the interactive surface unit 1.

FIG. 2 shows a block diagram of another embodiment of an interactive surface and display system wherein the integrated interactive surface unit 20 is enhanced by additional computing capabilities enabling it to run applications 11 on its own. The integrated interactive surface unit 20 contains a power supply 7, a position identification unit 5, an integrated display unit 6 and an I/O unit 13 as described previously in FIG. 1.

The integrated interactive surface system 20 contains a smart controller 23 that is responsible for synchronizing the operations of all the elements of the integrated interactive surface unit 20 and in addition is also responsible for running the software applications 11. The smart controller 23 also fills the functions of the application 11 layer, logic and engine 10 layer and driver 9 as described above for FIG. 1.

Software applications 11 can be preloaded to the integrated interactive surface 20. Additional or upgraded application 11 can be received from external elements including but not limited to: a memory card, a computer, a gaming console, a local or external network 27, the Internet, a handheld terminal, or a portable device 28.

In another embodiment of the invention, the external multimedia computer 2 loads the appropriate software application 11 to the integrated interactive surface 20. One or more external monitors or television sets 12 are used to display control information to the operator of the service, or to display additional information or guidance to the user of the application 11. In one aspect of the present invention, the external monitor or television set 12 presents the user with pertinent data regarding the application 11 or provides help regarding how to interact with the specific application 11.

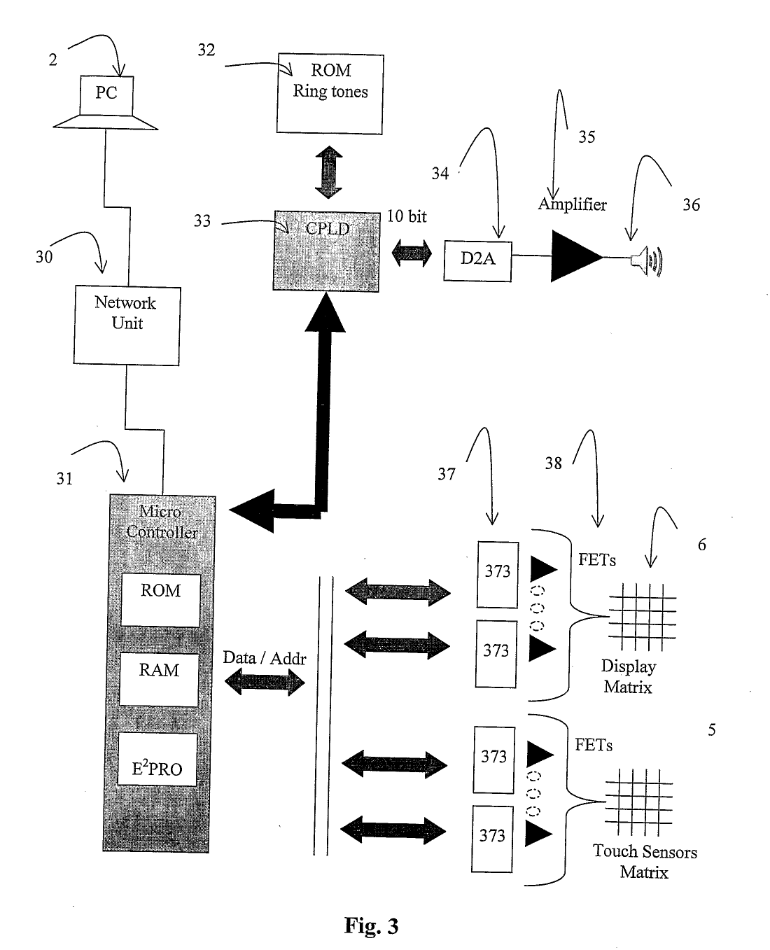

FIG. 3 illustrates a block diagram of the main electronic components. The micro controller 31 contains different types of memory adapted for specific tasks. The Random Access Memory (RAM) contains the data of the application 11 at run-time and its current status. Read Only Memory (ROM) is used to store preloaded application 11. Electrically Erasable Programmable ROM (EEPROM) is used to store pertinent data relevant to the application or to the status of the application 11 at a certain stage. If a user interacts with an application 11 and wishes to stop the application 11 at a certain stage and then resume using the application 11 later on at the same position and condition he has stopped the application 11, then pertinent application 11 data is stored in EEPROM memory. Each memory units mentioned can be easily implemented or replaced by other known or future memory technology, for instance, hard disks, flash disks or memory cards.

The micro controller 31 connects with three main modules: the position identification 5 matrix and display 6 matrix; peripheral systems such as a multimedia computer 2, a game console, a network 27, the Internet, an external monitor or television set 12 or a portable device 28; and the sound unit 24.

The position identification 5 matrix and the display 6 matrix are built and behave in a similar way. Both matrices are scanned with a given interval to either read a value from each position identification 5 matrix junction or to activate with a given value each junction of the display 6 matrix. Each display 6 junction contains one or more Light Emitting Diodes (LED). Each position identification 5 junction contains either a micro-switch or a touch sensor, or a proximity sensor. The sensors employ any one of the following technologies: (i) resistive touch-screen technology; (ii) capacitive touch-screen technology; (iii) surface acoustic wave touch-screen technology; (iv) infrared touch-screen technology; (v) near field imaging touch-screen technology; (vi) a matrix of optical detectors of a visible or invisible range; (vii) a matrix of proximity sensors with magnetic or electrical induction; (viii) a matrix of proximity sensors with magnetic or electrical induction wherein the users or objects carry identifying material with a magnetic signature; (ix) a matrix of proximity sensors with magnetic or electrical induction wherein users or objects carry identifying RFID tags; (x) a system built with one or more cameras with image identification technology; (xi) a system built with an ultra-sound detector wherein users or objects carry ultra-sound emitters; (xii) a system built with RF identification technology; or (xiii) any combination of (i) to (xii).

The above implementation of the position identification unit 5 is not limited only to a matrix format. Other identification technologies and assemblies can replace the above matrix based description, as elaborated in the explanation of FIG. 1.

The digital signals pass from the micro controller 31 through a latch such as the 373 latch 37 or a flip flop, and then to a field-effect transistor (FET) 38 that controls the LED to emit the right signal on the X-axis. At the same time, appropriate signals arrive to a FET 38 on the Y-axis. The FET 38 determines if there is a ground connection forming alternate voltage change on the LED's to be lit.

Resistive LCD touch-screen monitors rely on a touch overlay, which is composed of a flexible top layer and a rigid bottom layer separated by insulating dots, attached to a touch-screen micro controller 31. The inside surface of each of the two layers is coated with a transparent metal oxide coating, Indium Tin Oxide (ITO), that facilitates a gradient across each layer when voltage is applied. Pressing the flexible top sheet creates electrical contact between the resistive layers, producing a switch closing in the circuit. The control electronics alternate voltage between the layers and pass the resulting X and Y touch coordinates to the touch-screen micro controller 31.

All the sound elements are stored in a predefined ROM. A Complex programmable logic device (CPLD) 33 emits the right signal when requested by the controller. A 10-bit signal is converted to an analog signal by a Digital to Analog (D2A) 34 component, and then amplified by an amplifier 35 and sent to a loud speaker 36. The ROM 32 consists of ringtone files, which are transferred through the CPLD 33, when requested by the Micro Controller 31.

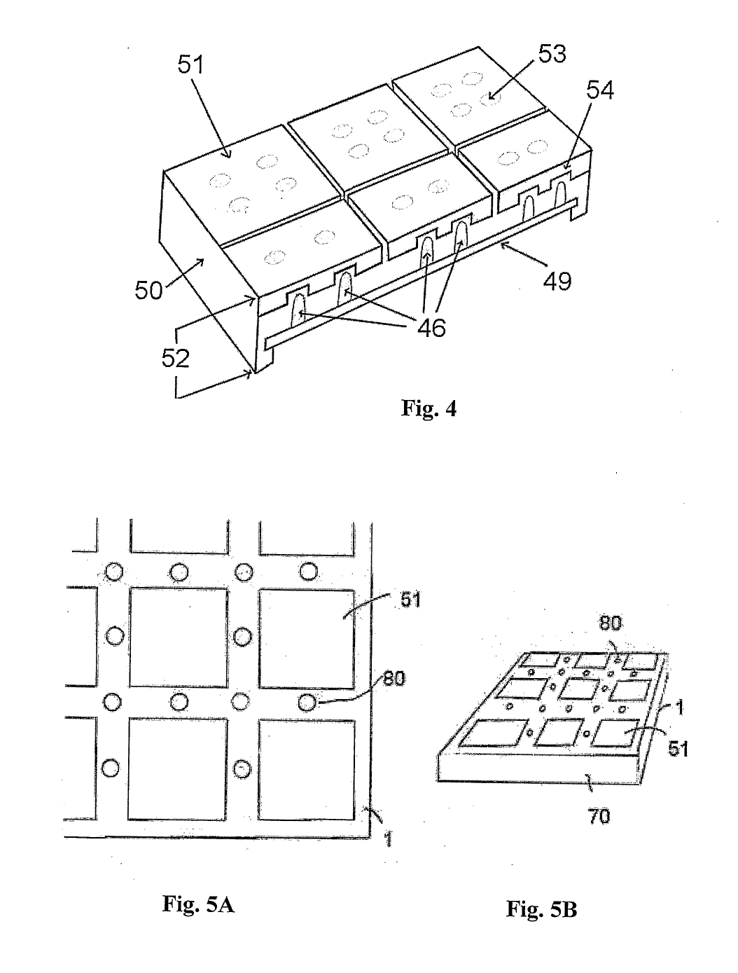

FIG. 4 illustrates the physical structure of the integrated interactive surface unit 20. The main layer is made of a dark, enforced plastic material and constitutes the skeleton of the screen. It is a dark layer that blocks light, and defines by its structure the borders of each display segment of the integrated interactive surface unit 20. This basic segment contains one or more pixels. The size of the segment determines the basic module that can be repaired or replaced. This layer is the one that is in contact with the surface on which the integrated interactive surface 20 or interactive surface 1 is laid upon. In one embodiment of the present invention, each segment contains 2 pixels, wherein each pixel contains 4 LEDs 46. Each LED 46 is in a different color, so that a combination of lit LEDs 46 yields the desired color in a given pixel at a given time. It is possible to use even a single LED 46 if color richness is not a priority. In order to present applications with very good color quality, it is necessary to have at least 3 LEDs 46 with different colors. Every LED 46 is placed within a hollow space 54 to protect it when pressure is applied against the display unit 6.

The LEDs 46 with the controlling electronics are integrated into the printed circuit board (PCB) 49. The LED 46 is built into the enforced plastic layer so that it can be protected against the weight applied against the screen surface including punches and aggressive activity. The external layer is coated with a translucent plastic material 51 for homogeneous light diffusion.

In the example shown in FIG. 4, the body 50 of the integrated interactive surface unit 20 is composed of subunits of control, display and touch sensors. In this case, the subunit is composed of 6 smaller units, wherein each said smaller unit contains 4 LEDs 46 that form a single pixel, a printed circuit, sensors and a controller.

FIGS. 5a, 5b illustrate a position identification system 5 whose operation resembles that of pressing keyboard keys. The integrated display unit 6 includes the skeleton and the electronics. A small, resistant and translucent plastic material 51 is either attached to or glued to the unit's skeleton 70. The display layer is connected to the integrated display unit 6 via connection pins 80.

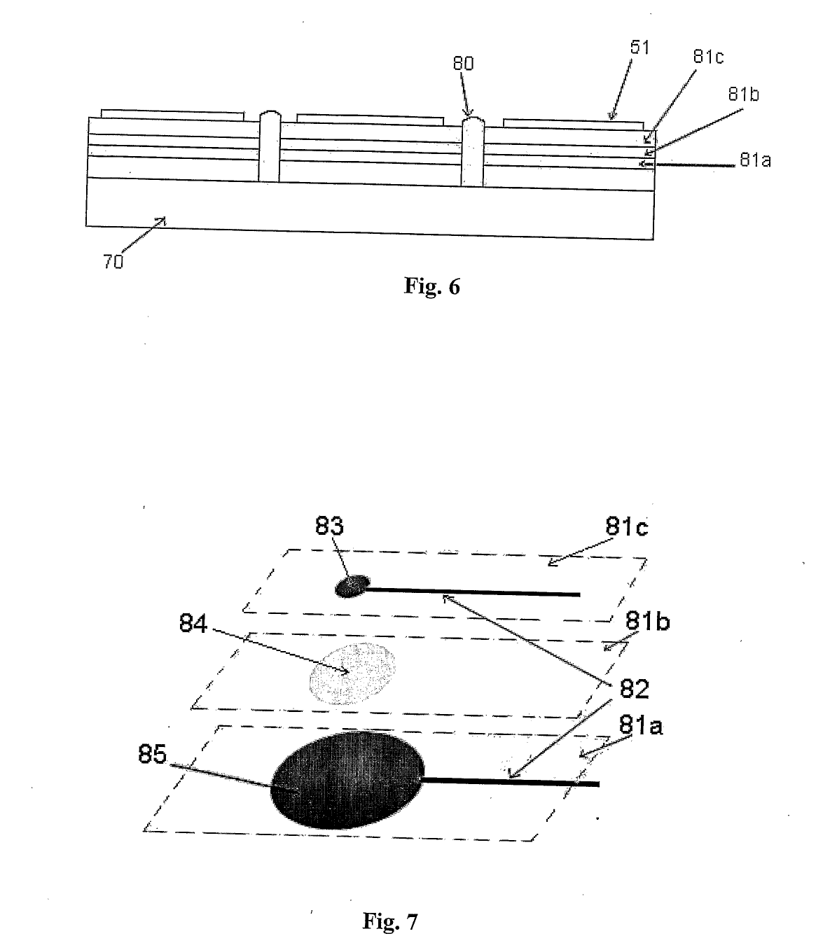

FIG. 6 illustrates a side view of position identification sensors, built in three layers marked as 81a, 81b and 81c, one on top of the other. Every layer is made of a thin, flexible material. Together, the three layers form a thin, flexible structure, laid out in a matrix structure under the translucent plastic material 51 and protective coating as illustrated in FIG. 6.

FIG. 7 illustrates a closer look of the three layers 81a, 81b and 81c. It is necessary to have a support structure between the lowest layer 81c and the unit's skeleton 70, so that applying pressure on the top layer 81a will result in contact with the appropriate sensor of each layer. The top layer 81a has a small carbon contact 83 that can make contact with a larger carbon sensor 85 through an opening 84 in the second layer 81b. The carbon sensors 83, 85 are attached to a conductive wire.

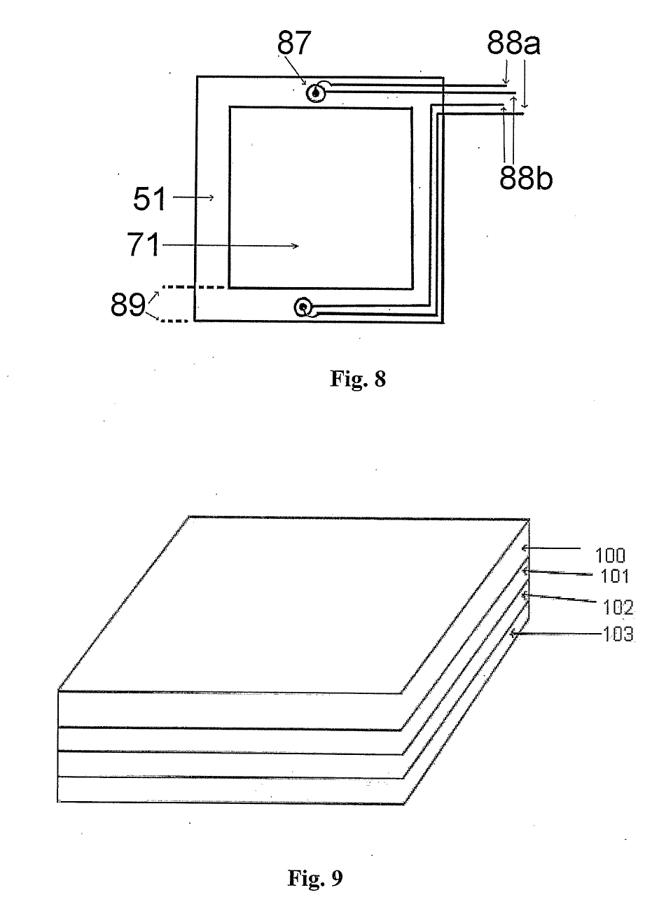

FIG. 8 illustrates an example of how position identification sensors can be placed around a pixel. One or more flat touch sensors 87 surround the inner space of the pixel 71 that hosts the light source of the pixel. The flat touch sensors 87 are connected to wired conductors 88a and 88b leading either to the top layer 81a or the bottom layer 81c.

The exact number and location of the flat touch sensors 87 are determined by the degree of accuracy desired by the positioning system. A pixel 71 may have one or more associated flat touch sensors 87, or a flat touch sensor 87 may be positioned for every few pixels 71. In the example of FIG. 5, two flat touch sensors 87 are positioned around each pixel 71.

In another embodiment of the present invention, further touch sensors 87 are placed between two transparent layers 81, thus getting an indication of contact within the area of a pixel 71, allowing tracking of interaction inside lighting or display sections.

FIG. 9 illustrates the usage of flexible display technologies such as OLED, FOLED, PLED or EL. On top is a further transparent, protection layer 100 for additional protection of the display and for additional comfort to the user. Underneath is the actual display layer 101 such as OLED, FOLED, PLED or EL. Below the display layer 101 lays the position-identification layer 102 that can consist of any sensing type, including specific contact sensors as in 81. The position-identification layer 102 contains more or less touch sensors 87 depending on the degree of position accuracy required or if external position identification means are used. The position-identification layer 102 can be omitted if external position identification means are used. The bottom layer is an additional protection layer 103.

The display layer 101 and the position-identification layer 102 can be interchanged if the position-identification layer 102 is transparent or when its density does not interfere with the display.

The display layer 101, position-identification layer 102, and additional protection layer 103 may either touch each other or be separated by an air cushion for additional protection and flexibility. The air cushion may also be placed as an external layer on top or below the integrated display system 6. The air cushion's air pressure is adjustable according to the degree of flexibility and protection required, and can also serve, as for entertainment purposes, by adjusting the air pressure according to the interaction of a user or an object.

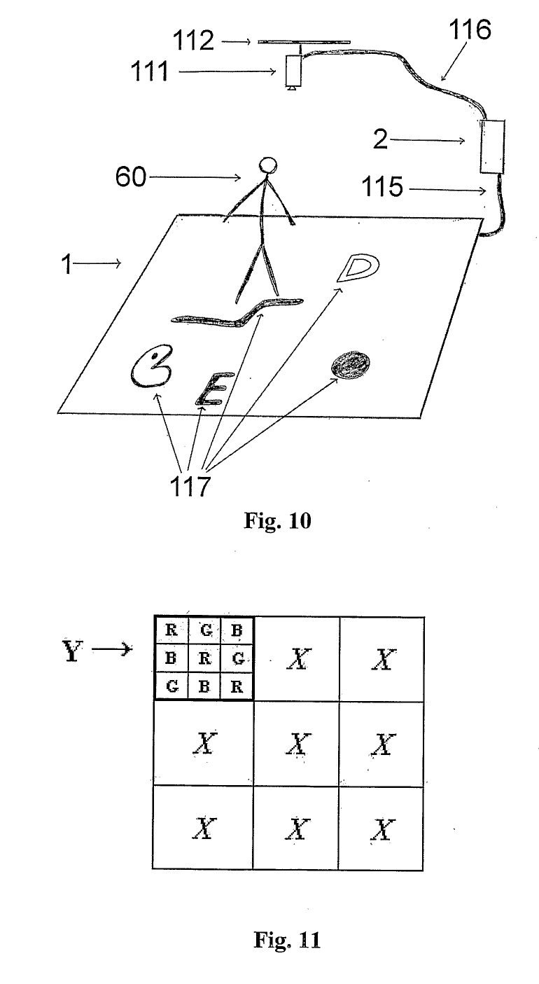

FIG. 10 illustrates an interactive surface 1 with an external video projector 111 attached to a holding device 112 placed above the interactive surface 1 as shown. According to the invention, more than one external video projector(s) 111 may be used, placed in any space above, on the side or below the interactive surface 1.

The external video projector 111 is connected to a multimedia computer 2 by the appropriate video cable 116. The video cable 116 may be replaced by a wireless connection. The multimedia computer 2 is connected to the interactive surface 1 by the appropriate communication cable 115. The communication cable 115 may be replaced by a wireless connection. The external video projector 111 displays different objects 117 based on the interaction of the user 60 with the interactive surface 1.

FIG. 11 illustrates how a display pixel 71 is built. A pixel 71 can be divided into several subsections marked as X. Subsections can either be symmetric, or square or of any other desired form. Each subsection is lit with a given color for a given amount of time in order to generate a pixel 71 with the desired color. Subsection Y is further divided into 9 other subsections, each marked with the initial of the primary color it can display: R (Red), G (Green), B (Blue).

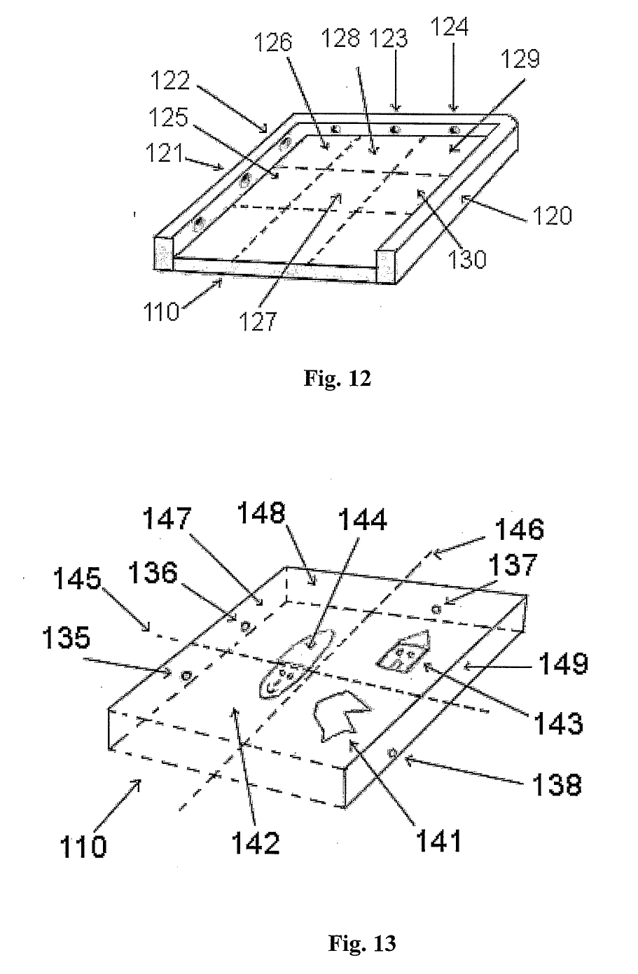

FIG. 12 illustrates an interactive display system wherein the content is displayed using projectors 121, 122, 123 and 124 embedded in the sidewalls 120 of the interactive unit 110, a little above the contact or stepping area so that the projection is done on the external layer 100. Both the projector and the positioning system are connected to and synchronized by the Controller 4, based on the interaction with the user. Each projector covers a predefined zone. Projector 121 displays content on area 125; projector 122 displays content on area 126; projector 123 displays content on areas 127 and 128; and projector 124 displays content on areas 129 and 130.

FIG. 13 illustrates an interactive display system wherein the content is displayed using projectors 135, 136, 137 and 140 embedded in the sidewalls 147, 148 and 149 of the interactive unit 110, a little below the contact or stepping area so that the projection comes through an inside transparent layer underneath the external transparent layer 100. Both the projector and the positioning system are connected to and synchronized by the Controller 4, based on the interaction with the user. Each projector covers a predefined zone. Projector 135 displays the face 142; projector 136 displays the hat 144; projector 137 displays the house 143; and projector 138 displays the form 141.

When the face 142 and hat 144 move up, projector 135 displays only part of the face 142 while projector 136 displays the rest of the face 142 in its own zone, and the hat 144 in its updated location.

It is also possible to use projectors from above, or any combination of different projectors in order to improve the image quality.

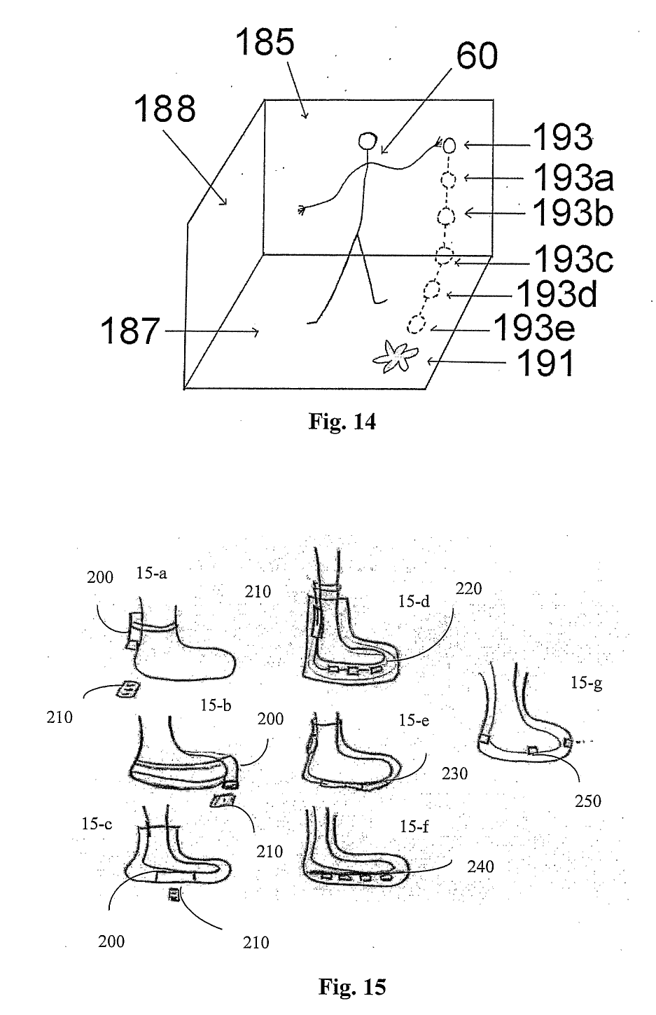

FIG. 14 illustrates 3 interactive display systems 185, 186 and 187, all integrated into a single, working interactive display system. The chasing FIG. 191 is trying to catch an interactive participant 60 that for the moment is not in contact with it. The interactive participant 60 touches the object 193 on the display system 185 thus making it move towards display system 187, shown in the path of 193a through 193e. If object 193 touches chasing FIG. 191, it destroys it.

FIGS. 15a-g illustrate several examples of wearable accessories of the invention that assist in identifying the user's position. FIGS. 15a, 15b and 15c illustrate an optical scanner 200 or other optical means able to scan a unique pattern or any other image or shape of surface 210 in an interactive surface 1. The pattern can be a decoration, printing, shape of surface or image. The optical scanner 200 has its own power supply and means for transmitting information such as through radio frequency and can be placed on the back of the foot (FIG. 15a), on the front of the foot (FIG. 15b) or built into the sole of a shoe. FIGS. 15d, 15e and 15f illustrate a sock or an innersole containing additional sensors. The sensors can be pressure sensors 220, magnets 230, RF 240 or RFID sensors, for example. EMG sensors is another alternative. FIGS. 15d and 15e illustrate a sock or innersole that also covers the ankle, providing thus more information about the foot movement. FIG. 15g illustrates a shoe with integrated LED 250 or other light points.

These wearable devices and others like: gloves, pads, sleeves, belts, cloths and the like are used for acquiring data and stimulating the user, and also can optionally be used for distinguishing the user and different parts of the body by inductions or conduction of the body with unique electrical attributes measured by sensors embedded in the interactive surface 1 or covering the interactive surface 1 area. Thus, the interactive surface 1 can associate each user and object with corresponding contact points. Another option is to use a receiver on the wearable device. In this case unique signals transmitted through the contact points of the wearable are received at the wearable and sent by a wireless transmitter to the system identifying the location and the wearable and other associated parameters and data acquired.

A few light sources on different positions can aid the system in locating the position of the shoe. The light sources, when coupled with an optical sensor, scanner or camera are used to illuminate the interactive surface, to improve and enable reading the images and patterns. These LEDs or lighting sources can also serve as a type of interactive gun attached to the leg. As in interactive guns, when pointed at a display, the display is affected. Tracking the display's video out can assist in positioning the location of contact between the beam of light and the display. This display can be an integrated display or an independent display attached to the system.

Many types of sensors can be used in the present invention. Sensors can collect different types of data from the user like his pulse, blood pressure humidity, temperature, muscle use (EMG sensors), nerve and brain activity etc. Sensors that can be used in the present invention should preferably fulfill one or more of the following needs:
(i) enriching the interactive experience by capturing and responding to more precise and subtle movements by the user or object;
(ii) generating appropriate content according to the identification data acquired;
(iii) providing online or offline reports regarding the usage and performance of the system so that the user or the person responsible for the operation of the system can adjust the manner of use, review performance and achievements, and fine-tune the system or application;
(iv) serve as biofeedback means for controlling, diagnosing, training and improving the user's physical and mental state;
(v) tracking and improving energy consumption by the user while performing a given movement or series of movements; and/or
(vi) tracking and improving movement quality by a user while performing a given movement or series of movements.

Sensors can also identify the user by scanning the finger prints of the leg or hand or by using any other biometrics means. An accelerometer sensor is used to identify the nature of movements between given points in the interactive surface 1.

The information derived from the various sensors helps the system analyze the user or object's movements even beyond contact with the interactive surface 1. Hence, an RF device or appropriate sensors such as an accelerometer, magnetic, acoustic or optical sensor can deduce the path of movement from point A to point B in the interactive surface 1 for example, in a direct line, in a circular movement or by going up and down.

The movement is analyzed and broken down into a series of information blocks recording the height and velocity of the leg so that the location of the leg in the space above the interactive surface 1 is acquired.

In another embodiment of the present invention, the system communicates with a remote location networking means including, but not limited to, wired or wireless data networks such as the Internet; and wired or wireless telecommunication networks.

In yet another embodiment of the present invention, two or more systems are connected sharing the same server. The server runs the applications 11 and coordinates the activity and content generated for each system. Each system displays its own content based on the activity performed by the user or object in that system, and represents on the display 3 both local and remote users participating in the same application 11. For instance, each system may show its local users, i.e., users that are physically using the system, represented by a back view, while users from other systems are represented as facing the local user or users.

For example, in a tennis video game application 11, the local user is shown with a back view on the bottom or left side of his display 3, while the other remote user is represented by a tennis player image or sprite on the right or upper half of the display 3 showing the remote user's front side.

In instances where two or more systems are connected, the logic and engine modules 10 and application 11 modules are distributed over the network according to network constrains. One possible implementation is to locate the logic and engine module 10 at a server, with each system running a client application 11 with its suitable view and customized representation.

This implementation can serve as a platform for training, teaching and demonstration serving a single person or a group. Group members can be either distributed over different systems and also locations or situated at the same system. The trainer can use a regular computer to convey his lessons and training or use an interactive surface 1. The trainer's guidance can be, for example, by interacting with the user's body movements which are represented at the user's system by a suitable content and can be replayed for the user's convenience. The trainer can edit a virtual image of a person to form a set of movements to be conveyed to the user or to a group of users. Another technique is to use a doll with moving body parts. The trainer can move it and record the session instead of using his own body movements. For instance, the invention can be used for a dance lesson: the trainer, a dance teacher, can demonstrate a dance step remotely, which will be presented to the dance students at their respective systems. The teacher can use the system in a recording mode and perform his set of movements on the interactive surface 1. The teacher's set of movements can then be sent to his students. The students can see the teacher's demonstration from their point of view and then try to imitate the movements. The dance teacher can then view the students' performance and respond so they can learn how to improve. The teacher can add marks, important feedback to their recorded movements and send the recordings back to the students. The server can save both the teacher's and students' sessions for tracking progress over time and for returning to lesson sessions at different stages. The sessions can be edited at any stage.

A trainer can thus connect with the system online or offline for example in order to change its settings, review user performance and leave feedback, instructions and recommendation to the user regarding the user's performance. The term “trainer”, as used herein, refers to any 3^{rd} party person such as an authorized user, coach, health-care provider, guide, teacher, instructor, or any other person assuming such tasks.

In yet another embodiment of the present invention, said trainer conveys feedback and instructions to the user while said user is performing a given activity with the system. Feedback and instructions may be conveyed using remote communications means including, but not limited to, a video conferencing system, an audio conferencing system, a messaging system, or a telephone.

In one embodiment of the present invention, a sensor is attached to a user, or any body part of the user such as a leg or a hand, or to an object. Said sensor then registers motion information to be sent out at frequent intervals wirelessly to the controller 4. The controller 4 then calculates the precise location by adding each movement to the last recorded position.

Pressure sensors detect the extent and variation in pressure of different body parts or objects in contact with the interactive surface 1.

In another embodiment of the present invention, a wearable one or more source lights or LEDs emits light so that an optical scanner or a camera inspecting the interactive surface 1 can calculate the position and movements of the wearable device. When lighting conditions are insufficient, the source lights can be replaced by a wearable image or pattern, scanned or detected by one or more optical sensors or cameras to locate and/or identify the user, part of user or object. As an alternative, a wearable reflector may be used to reflect, and not to emit, light.

In another embodiment of the present invention, the emitted light signal carries additional information beyond movement and positioning, for example, user or object identification, or parameters received from other sensors or sources. Reflectors can also transmit additional information by reflecting light in a specific pattern.

The sensors can be embedded into other objects or wearable devices like a bracelet, trousers, skates, shirt, glove, suit, bandanna, hat, protector, sleeve, watch, knee sleeve or other joint sleeves, jewelry and into objects the user holds for interaction like a game pad, joystick, electronic pen, all 3d input devices, stick, hand grip, ball, doll, interactive gun, sward, interactive guitar, or drums, or in objects users stand on or ride on like crutches, spring crutches, or in a skateboard, all bicycle types with different numbers of wheels, and motored vehicles like segway, motorcycles and cars. In addition, sensors can be placed in stationary objects the user can position on the interactive surface 1 such as bricks, boxes, regular cushions. These sensors can also be placed in moving toys like robots or remote control cars.

In yet another embodiment of the present invention, the portable device 28 acts as a computer 2 itself with its corresponding display 3. The portable device 28 is then used to control the interactive surface 1 unit.

In yet another embodiment of the present invention, a portable device 28 containing a camera and a screen can also be embedded or connected to a toy such as a shooting device or an interactive gun or any other device held, worn or attached to the user. The display of the portable device 28 is then used to superimpose virtual information and content with the true world image as viewed from it. The virtual content can serve as a gun's viewfinder to aim at a virtual object on other displays including the display unit 6. The user can also aim at real objects or users in the interactive environment.

Some advanced portable devices 28 can include image projection means and a camera. In yet another embodiment of the present invention, the camera is used as the position identification unit 5. For instance, a user wearing a device with light sources or reflecting means is tracked by the portable device's 28 camera. Image projection means are used as the system's display unit 6.

In another embodiment of the present invention, the position identification unit 5 is built with microswitches. The microswitches are distributed according to the precision requirements of the position identification unit 5. For the highest position identification precision, the microswitches are placed within each pixel 71. When the required identification resolution is lower, a microswitch can be placed only on certain, but not on all pixels 71.

In one embodiment of the invention, the direction of movement of any user or object in contact with the interactive surface 1 or integrated interactive surface system 20 is detected. That is, the current position of a user or object is compared with a list of previous positions, so that the direction of movement can be deducted from the list. Content applications 11 can thus use available information about the direction of movement of each user or object interacting with said interactive surface 1 and generate appropriate responses and feedback in the displayed content.

In yet another embodiment of the invention, the extent of pressure applied against the interactive surface 1 or integrated interactive surface 20 by each user or object is measured. Content applications 11 can thus use available information about the extent of pressure applied by each user or object against said interactive surface 1 or integrated interactive surface 20 and generate appropriate responses and feedback in the displayed content.

In yet a further embodiment of the invention, the system measures additional parameters regarding object(s) or user(s) in contact with said interactive surface 1 or integrated interactive surface system 20. These additional parameters can be sound, voice, speed, weight, temperature, inclination, color, shape, humidity, smell, texture, electric conductivity or magnetic field of said user(s) or object(s), blood pressure, heart rate, brain waves and EMG readings for said user(s), or any combination thereof. Content applications 11 can thus use these additional parameters and generate appropriate responses and feedback in the displayed content.

In yet a further embodiment of the invention, the system detects specific human actions or movements, for example: standing on one's toes, standing on the heel, tapping with the foot in a given rhythm, pausing or staying in one place or posture for an amount of time, sliding with the foot, pointing with and changing direction of the foot, determining the gait of the user, rolling, kneeling, kneeling with one's hands and knees, kneeling with one's hands, feet and knees, jumping and the amount of time staying in the air, closing the feet together, pressing one area several times, opening the feet and measuring the distance between the feet, using the line formed by the contact points of the feet, shifting one's weight from foot to foot, or simultaneously touching with one or more fingers with different time intervals.

It is understood that the invention also includes detection of user movements as described, when said movements are timed between different users, or when the user also holds or operates an aiding device, for example: pressing a button on a remote control or game pad, holding a stick in different angles, tapping with a stick, bouncing a ball and similar actions.

The interactive surface and display system tracks and registers the different data gathered for each user or object. The data is gathered for each point of contact with the system. A point of contact is any body member or object in touch with the system such as a hand, a finger, a foot, a toy, a bat, and the like. The data gathered for each point of contact is divided into parameters. Each parameter contains its own data vector. Examples of parameters include, but are not limited to, position, pressure, speed, direction of movement, weight and the like. The system applies the appropriate function on each vector or group of vectors, to deduct if a given piece of information is relevant to the content generated.

The system of the invention can track compound physical movements of users and objects and can use the limits of space and the surface area of objects to define interactive events. The system constantly generates and processes interactive events. Every interactive event is based on the gathering and processing of basic events. The basic events are gathered directly from the different sensors. As more basic events are gathered, more information is deducted about the user or object in contact with the system and sent to the application as a compound interactive event, for example, the type of movement applied (e.g. stepping with one foot twice in the same place, drawing a circle with a leg etc.), the strength of movement, acceleration, direction of movement, or any combination of movements. Every interactive event is processed to see if it needs to be taken into account by the application generating the interactive content.

Identifying with high-precision the points of contact with the system allows generation of more sophisticated software applications. For example, if the system is able to identify that the user is stepping on a point with the front part of the foot as opposed to with the heel, then combined with previous information about the user and its position, a more thorough understanding of the user's actions and intensions is identified by the system, and can be taken into account when generating the appropriate content.

The present invention can further be used as a type of a joystick or mouse for current applications or future applications by taking into account the Point of Equilibrium calculated by one user or a group of users or objects. The Point of Equilibrium can be regarded as an absolute point on the interactive surface 1 or in reference to the last point calculated. This is also practical when the interactive surface 1 and the display unit 3 are separated, for example, when the interactive surface 1 is on the floor beside the display 3. Many translation schemes are possible, but the most intuitive is mapping the display rectangular to a corresponding rectangular on the interactive surface 1. The mapping could then be absolute: right upper corner, left upper corner, right bottom corner and left bottom corner of the display to the right upper corner, left upper corner, right bottom corner and left bottom corner of the interactive surface 1. Other positions on the display 3 and interactive surface 1 are mapped in a similar fashion. Another way of mapping resembles the functionality of a joystick: moving the point of equilibrium from the center in a certain direction will move the cursor or the object manipulated in the application 11 to the corresponding direction for the amount of time the user stays there. This can be typically used to navigate inside an application 11 and move the mouse cursor or a virtual object in a game, an exercise, a training session or for medical and rehabilitation applications 11, for example, in such programs using balancing of the body as a type of interaction. The user can balance on the interactive surface 1 and control virtual air, ground, water and space vehicles or real vehicles making the interactive surface 1 a type of remote control.

The above mouse-like, joystick-like or tablet-like application can use many other forms of interaction in order to perform the mapping besides using the point of equilibrium as enrichment or as a substitute. For example, the mapping can be done by using the union of contact points, optionally adding their corresponding measurements of pressure. This is especially useful when manipulating an image bigger than a mouse cursor. The size of this image can be determined by the size of the union of contact areas. Other types of interactions, predefined by the user, can be mapped to different actions. Examples of such interactions include, but are not limited to, standing on toes; standing on one's heel; tapping with the foot in a given rhythm; pausing or staying in one place or posture for an amount of time; sliding with the foot; pointing with and changing direction of the foot ; rolling; kneeling; kneeling with one's hands and knees (all touching interactive surface); kneeling with one's hands, feet and knees (all touching interactive surface); jumping and the amount of time staying in the air; closing the feet together; pressing one area several times; opening the feet and measuring the distance between the feet; using the line formed by the contact points of the feet; shifting one's weight from foot to foot; simultaneously touching with one or more fingers with different time intervals; and any combination of the above.

The present invention also enables enhancement of the user's experience when operating standard devices such as a remote control, game pad, joystick, or voice recognition gear, by capturing additional usage parameters, providing the system more information about the content of the operation. When pressing a standard button on a remote control, the system can also identify additional parameters such as the position of the user, the direction of movement of the user, the user's speed, and the like. Additional information can also be gathered from sensors installed on a wearable item or an object the user is using such as a piece of clothing, a shoe, a bracelet, a glove, a ring, a bat, a ball, a marble, a toy, and the like. The present invention takes into account all identified parameters regarding the user or object interacting with said system when generating the appropriate content.

The present invention also enhances movement tracking systems that do not distinguish between movement patterns or association with specific users or objects. The information supplied by the interactive surface 1 or integrated interactive system 20 is valuable for optical and other movement tracking systems, serving in a variety of applications such as, but not limited to, security and authorization systems, virtual reality and gaming, motion capture systems, sports, training and rehabilitation. In sports, the present invention can also be very useful in assisting the referee, for example, when a soccer player is fouled and the referee needs to decide if it merits a penalty kick or how many steps a basketball player took while performing a lay-up. The invention is also very useful in collecting statistics in sport games.

In another embodiment of the present invention, the display 3 module of the interactive surface 1 is implemented by a virtual reality and/or augmented reality system, for example, a helmet with a display 3 unit at the front and in proximity to the eyes, virtual reality glasses, a handheld, a mobile display system or mobile computer. The user can enjoy an augmented experience while looking at or positioning the gear in the direction of the interactive surface 1 making the content to be projected and viewed as if it is projected on the interactive surface 1 and a part of it.

Virtual Reality (VR) gear can show both the virtual content and the real-world content by several methods including, but not limited to:

1. adding a camera to the VR or augmented reality gear conveying the real world according to the direction of the head, position of the gear, and the line of sight; the real-world video is integrated with the virtual content, showing the user a combination of virtual content and real-world images;

2. while using VR gear, one eye is exposed so the true world is seen, while the other eye of the user sees the virtual content; and

3. the VR gear is transparent similar to a pilot's display so that the system can deduct the position of the user on the interactive system and project on the VR display the suitable content.

The interactive surface and display system can provide additional interaction with a user by creating vibration effects according to the action of a user or an object. In a further embodiment of the present invention, the interactive surface and display system contains integrated microphones and loud speakers wherein the content generated is also based on sounds emitted by a user or an object.

In another embodiment of the present invention, the interactive surface and display system can also use the interactive surface 1 to control an object in proximity to, or in contact with, it. For instance, the interactive surface and display system can change the content displayed on the display 3 so that optical sensors used by a user or object will read it and change their state or the interactive surface and display system can change the magnetic field, the electrical current, the temperature or other aspects of the interactive surface 1, again affecting the appropriate sensors embedded into devices the user or the object are using.

The interactive surface and display system can be positioned in different places and environments. In one embodiment of the invention, the interactive surface 1 or integrated display 6 is laid on, or integrated into, the floor. In another embodiment of the invention, the interactive surface 1 or integrated display 3 is attached to, or integrated into, a wall. The interactive surface 1 or integrated display 3 may also serve themselves as a wall.

Various display technologies exist in the market. The interactive surface 1 or integrated display system 20 employ at least one of the display technologies selected from the group consisting of: LED, PLED, OLED, Epaper, Plasma, three dimensional display, frontal or rear projection with a standard tube, and frontal or rear laser projection.

In another embodiment of the invention, the position identification unit 5 employs identification aids carried by, or attached to, users or objects in contact with the interactive surface 1 or integrated display system 20. The identification aids may be selected from: (i) resistive touch-screen technology; (ii) capacitive touch-screen technology; (iii) surface acoustic wave touch-screen technology; (iv) infrared touch-screen technology; (v) near field imaging touch-screen technology; (vi) a matrix of optical detectors of a visible or invisible range; (vii) a matrix of proximity sensors with magnetic or electrical induction; (viii) a matrix of proximity sensors with magnetic or electrical induction wherein the users or objects carry identifying material with a magnetic signature; (ix) a matrix of proximity sensors with magnetic or electrical induction wherein users or objects carry identifying RFID tags; (x) a system built with one or more cameras with image identification technology; (xi) a system built with an ultra-sound detector wherein users or objects carry ultra-sound emitters; (xii) a system built with RF identification technology; or (xiii) any combination of (i) to (xii).

The present invention is intended to be used both as a stand-alone system with a single screen or as an integrated system with two or more screens working together with the same content application 11.

In one embodiment of the invention, several interactive surfaces 1 or integrated interactive surfaces 20 are connected together, by wired or wireless means, to work as a single screen with a larger size. In this way, any user may purchase one interactive surface 1 or integrated interactive surface 20 and then purchase additional interactive surface units 1 or integrated interactive surface 20 at a later time. The user then connects all interactive surface units 1 or integrated interactive surface systems 20 in his possession, to form a single, larger-size screen. Each interactive surface 1 or integrated interactive surface system 20 displays one portion of a single source of content.

In yet another embodiment of the invention, two or more interactive surfaces 1 or integrated interactive surface systems 20 are connected together, by wired or wireless means, and are used by two or more users or objects. The application 11 generates a different content source for each interactive surface 1 or integrated interactive surface system 20. Contact by a user or object with one interactive surface 1 or integrated interactive surface system 20 affects the content generated and displayed on at least one interactive surface 1 or integrated interactive surface system 20. For example, multi-player gaming applications 11 can enable users to interact with their own interactive surface 1 or integrated interactive surface system 20, or with all other users. Each user sees and interacts with his proper gaming environment wherein generated content is affected by the action of the other users of the application 11.

Multi-user applications 11 do not necessarily require that interactive surface units 1 or integrated interactive surface systems 20 be within close proximity to each other. One or more interactive surface units 1 or integrated interactive surface systems 20 can be connected via a network such as the Internet.

The present invention makes possible to deliver a new breed of interactive applications 11 in different domains. For example, in applications 11 where interactive surface units 1 or integrated interactive surface systems 20 cover floors and walls, immerse the user into the application 11 by enabling the user to interact by running, jumping, kicking, punching, pressing and making contact with the interactive surface 1 or integrated interactive surface system 20 by using an object, thus giving the application 11 a more realistic and live feeling.

In a preferred embodiment of the invention, interactive display units are used for entertainment applications 11. A user plays a game by stepping on, walking on, running on, kicking, punching, touching, hitting, or pressing against said interactive surface 1 or integrated interactive surface system 20. An application 11 can enable a user to use one or more objects in order to interact with the system. Objects can include: a ball, a racquet, a bat, a toy, any vehicle including a remote controlled vehicle, and transportation aid using one or more wheels.

In a further embodiment of the invention, entertainment applications 11 enable the user to interact with the system by running away from and/or running towards a user, an object or a target.

In yet another embodiment of the invention, the interactive surface and display system is used for sports applications 11. The system can train the user in a sports discipline by teaching and demonstrating methods and skills, measuring the user's performance, offering advice for improvement, and letting the user practice the discipline or play against the system or against another user.

The present invention also enables the creation of new sports disciplines that do not exist in the real, non-computer world.

In yet another embodiment of the invention, the interactive surface and display system is embedded into a table. For example, a coffee shop, restaurant or library can use the present invention to provide information and entertainment simultaneously to several users sitting around said table. The table can be composed of several display units 6, which may be withdrawn and put back in place, also rotated and tilted to improve the comfort of each user. A domestic application of such table can also be to pilot different devices in the house including a TV, sound system, air conditioning and heating, alarm etc.

In yet another embodiment of the invention, the interactive surface and display system is used for applications 11 that create or show interactive movies.

In yet another embodiment of the invention, the interactive surface and display system is integrated into a movable surface like the surface found in treadmills. This enables the user to run in one place and change his balance or relative location to control and interact with the device and/or with an application like a game. Another example of a movable surface is a surface like a swing or balancing board or a surf board. The user can control an application by balancing on the board or swing, while his exact position and/or pressure are also taken into account.

In yet another embodiment of the invention, the interactive surface and display system is used as fitness equipment so that, by tracking the user's movements, their intensity and the accumulated distance achieved by the user, the application can calculate how many calories the user has burned. The system can record the users' actions and feedback him with a report on his performance.

In yet another embodiment of the invention, the interactive surface and display system is used for teaching the user known dances and/or a set of movements required in a known exercise in martial arts or other body movement activities like yoga, gymnastics, army training, Pilates, Feldenkrais, movement and/or dance therapy or sport games. The user or users can select an exercise like a dance or a martial arts movement or sequence and the system will show on the display 3 the next required movement or set of movements. Each movement is defined by a starting and ending position of any body part or object in contact with the interactive surface 1. In addition, other attributes are taken into consideration such as: the area of each foot, body part or object in contact with and pressuring the interactive surface 1; the amount of pressure and how it varies across the touching area; and the nature of movement in the air of the entire body or of a selected combination of body parts. The user is challenged to position his body and legs in the required positions and in the right timing.

This feature can also be used by a sports trainer or a choreographer to teach exercises and synchronize the movements of a few users. The trainer can be located in the same physical space as the practicing users or can supervise their practice from a remote location linked to the system by a network. When situated in the same space as the users, the trainer my use the same interactive surface 1 as the users. Alternatively, the trainer may use a separate but adjacent interactive surface 1, with a line of sight between the users and the trainer. The separate trainer space is denoted as the reference space. The trainer controls the user's application 11 and can change its setting from the reference space: selecting different exercises or a set of movements, selecting the degree of difficulty, and method of scoring. The trainer can analyze the performance by viewing reports generated from user activity and also comparing current performance of a user to historical data saved in a database.

In addition, the trainer can demonstrate to the users a movement or set of movements and send the demonstration to the users as a video movie, a drawing, animation or any combination thereof. The drawing or animation can be superimposed on the video movie in order to emphasize a certain aspect or point in the exercise and draw the user's attention to important aspects of the exercise. For instance, the trainer may want to circle or mark different parts of the body, add some text and show in a simplified manner the correct or desired path or movement on the interactive surface 1.

Alternatively, instead of showing the video of the trainer, an animation of an avatar or person representing the trainer or a group of avatars or persons representing the trainers is formed by tracking means situated at the reference space or trainer's space as mentioned before, and is shown to the users on their display system.

In yet another embodiment of the invention, the interactive surface and display system has one or more objects connected to it, so that they can be hit or pushed and stay connected to the system for repeated use. When this object is a ball, a typical application can be football, soccer, basketball, volleyball or other known sport games or novel sport games using a ball. When the object is a bag, a sack, a figure or a doll, the application can be boxing or other martial arts.

In yet another embodiment of the invention, the interactive surface and display system is used as a remote control for controlling a device like a TV set, a set-top box, a computer or any other device. The interactive surface signals the device by wireless means or IR light sources. For example, the user can interact with a DVD device to browse through its contents like a movie or sound system to control or interact with any content displayed and/or heard by the device. Another example for a device of the invention is a set top box. The user can interact with the interactive TV, browse through channels, play games or browse through the Internet.

In yet another embodiment of the invention, the interactive surface and display system is used instead of a tablet, a joystick or electronic mouse for operating and controlling a computer or any other device. The invention makes possible a new type of interaction of body movement on the interactive surface 1 which interprets the location and touching areas of the user to manipulate and control the content generated. Furthermore, by using additional motion tracking means, the movements and gestures of body parts or objects not in contact with the interactive surface 1 are tracked and taken into account to form a broader and more precise degree of interactivity with the content.

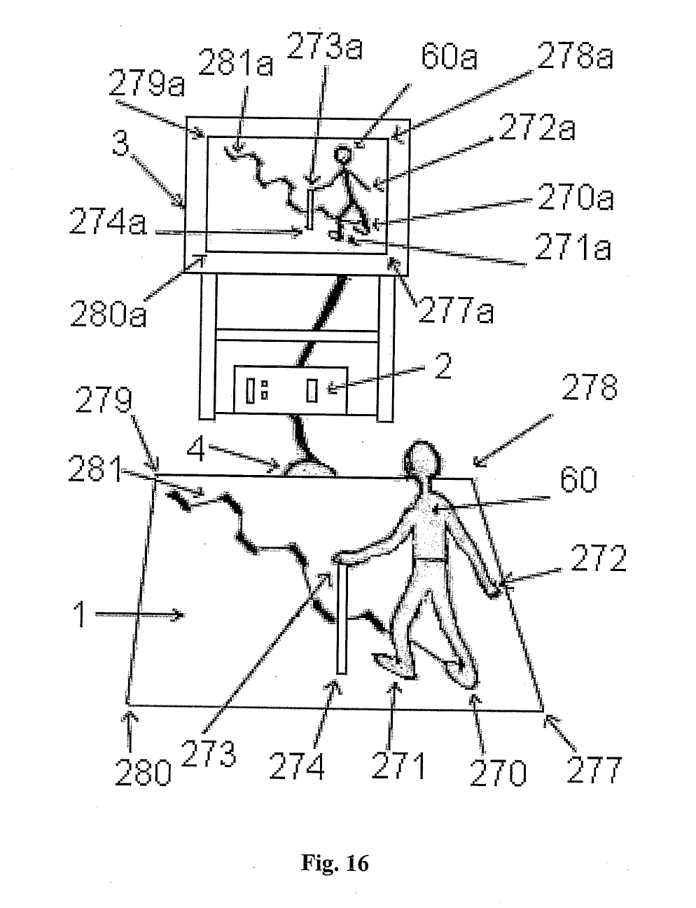

FIG. 16 shows an interactive surface 1 connected to a computer 2 and to a display 3. An interactive participant (user) 60 touches the interactive surface 1 with his right leg 270 and left leg 271. The interactive surface 1 acts as a tablet mapped to corresponding points on the display 3. Thus, the corners on the interactive surface 1, namely 277, 278, 279 and 280, are mapped correspondingly to the corners on the display 3: 277a, 278b, 279a and 280a. Therefore, the legs position on the interactive surface 1 are mapped on the display 3 to images representing legs at the corresponding location 270a and 271a. In order to match each interactive area of each leg with its original interactive participant's 60 leg, the system uses identification means and/or high resolution sensing means. Optionally, an auto-learning module is used, which is part of the logic and engine module 10, by comparing current movements to previously saved recorded movement patterns of the interactive participant 60. The interactive participant's 60 hands: right 272 and left 273 are also tracked by optional motion tracking means so the hands are mapped and represented on the display 3 at corresponding image areas 272a and 273a.

Therefore, the system is able to represent the interactive participant 60 on the display 3 as image 60a. The more the motion tracking means are advanced, the more the interactive participant's image 60a is represented closer to reality. The interactive participant 60 is using a stick 274, which is also being tracked and mapped correspondingly to its representation 274a. When the interactive surface 1 includes an integrated display module 6, a path 281 can be shown on it in order to direct, suggest, recommend, hint or train the interactive participant 60. The corresponding path is shown on the display 3. Suggesting such a path is especially useful for training the interactive participant 60 in physical and mental exercises, for instance, in fitness, dance, martial arts, sports, rehabilitation, etc. Naturally, this path 281 can be only presented in the display 3 and the interactive participant 60 can practice by moving and looking at the display 3. Another way to direct, guide or drive the interactive participant 60 to move in a certain manner is by showing a figure of a person or other image on the display 3, which the interactive participant 60 needs to imitate. The interactive participant's 60 success is measured by his ability to move and fit his body to overlap the figure, image or silhouette on the display 3.

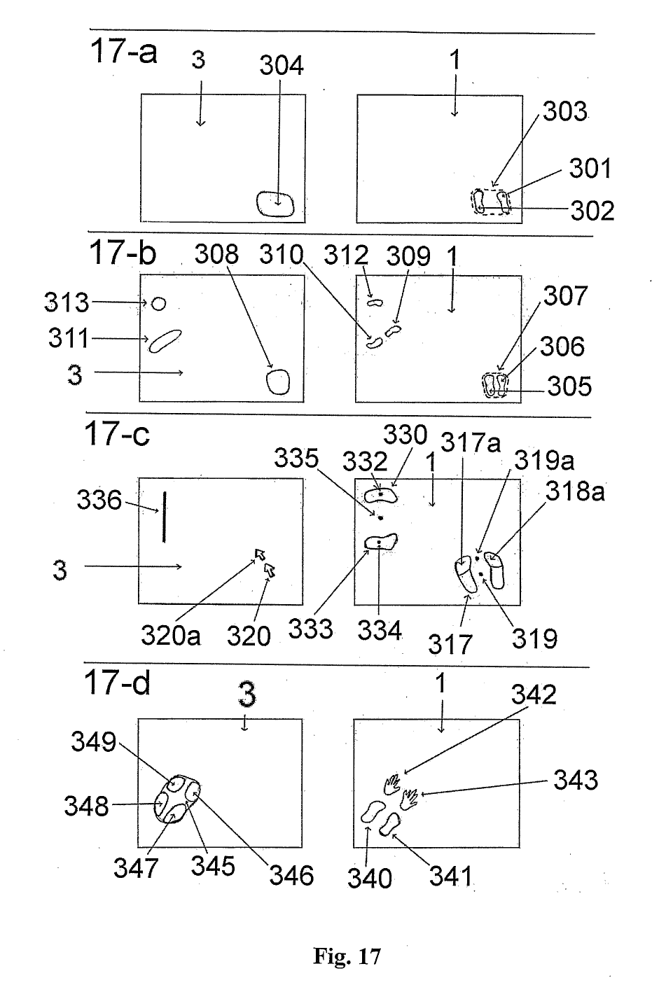

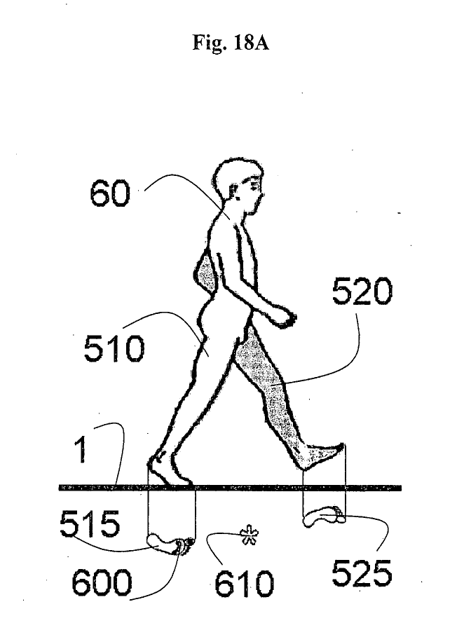

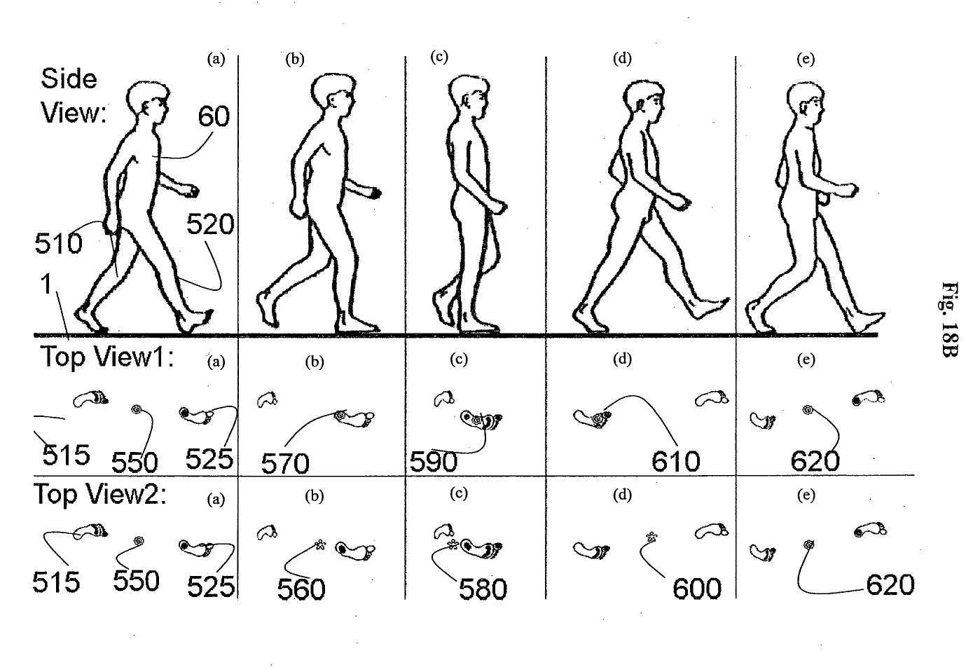

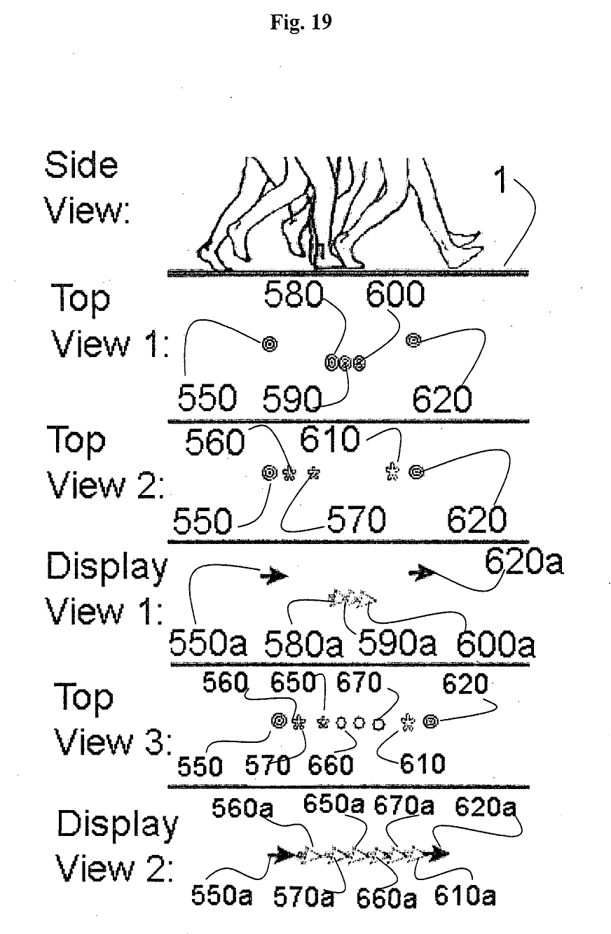

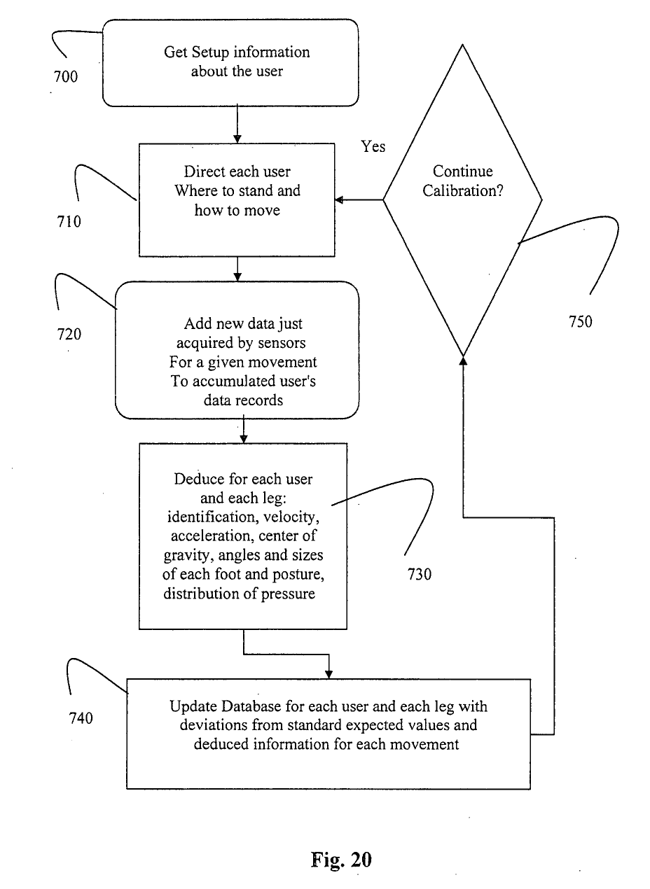

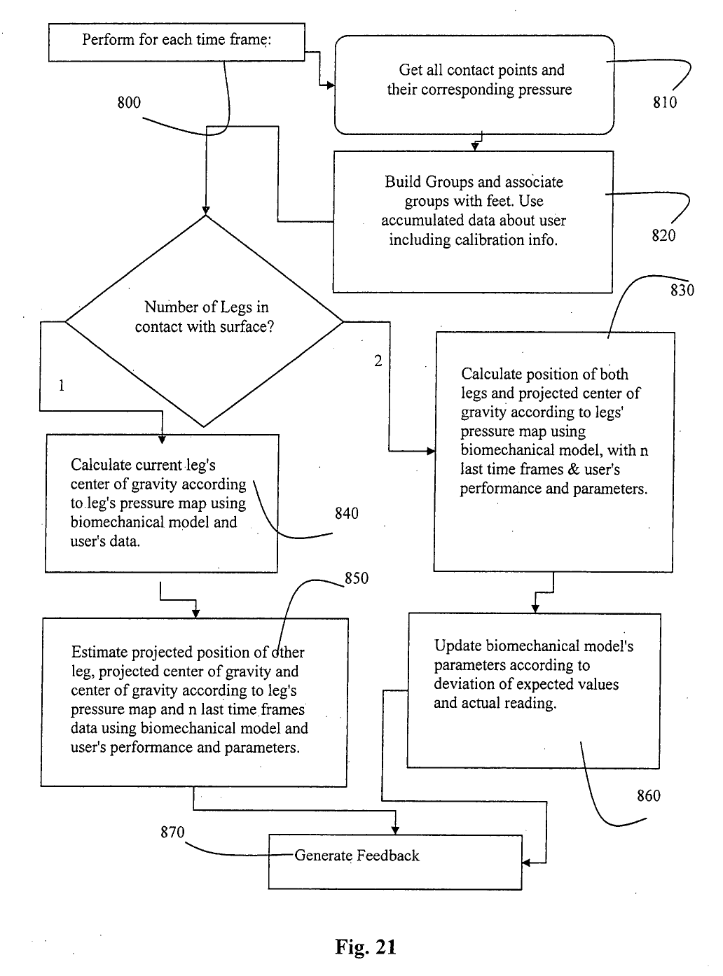

FIGS. 17a-d show four examples of usage of the interactive surface 1 to manipulate content on the display 3 and choices of representation. FIG. 17a shows how two areas of interactivity, in this case legs 301 and 302 are calculated into a union of areas together with an imaginary closed area 303 (right panel) to form an image 304 (left panel).

FIG. 17b illustrates how the interactive participant 60 brings his legs close together 305 and 306 to form an imaginary closed area 307 (right panel) which is correspondingly shown on the display 3 as image 308 (left panel). This illustrates how the interactive participant 60 can control the size of his corresponding representation. Optionally, the system can take into account pressure changes in the touching areas. For an instance, the image in the display 3 can be colored according to the pressure intensity at different points; or its 3D representation can change: high pressure areas can look like valleys or incurved while low pressed areas can look popping-out. The right panel also shows an additional interactive participant 60 standing at with his feet at positions 309 and 310 in a kind of tandem posture. This is represented as an elongated image 311 on the display 3 (left panel). Another interactive participant is standing on one leg 312, which is represented as image 313 (left panel).

Naturally, the present invention enables and supports different translations between the areas in contact with the interactive surface 1 and their representation on the display 3. One obvious translation is the straightforward and naive technique of showing each area on the interactive surface 1 at the same corresponding location on the display 3. In this case, the representation on the display 3 will resemble the areas on interactive surface 1 at each given time.

FIG. 17c illustrates additional translation schemes. The interactive participant 60 placed his left foot 317 and right foot 318 on the interactive surface 1 (right panel). The point of equilibrium is 319. The translation technique in this case takes the point of equilibrium 319 to manipulate a small image or act as a computer mouse pointer 320 (left panel). When the computer mouse is manipulated, other types of actions can be enabled such as a mouse click, scroll, drag and drop, select, and the like. These actions are translated either by using supplementary input devices such as a remote control, a hand held device, by gestures like double stepping by one leg at the same point or location, or by any hand movements. The right panel shows that when the interactive participant 60 presses more on the corresponding front parts of each leg, lifting his legs partially to leave only the upper parts of his foot, as when standing on toes, the point of equilibrium also moves, correspondingly effecting the mouse's pointer position to move to location 319a. An additional interactive participant 60 is at the same time pressing with his feet on areas 330 and 333 (right panel). Here, each foot's point of equilibrium: 332 and 334 is calculated and the entire point of equilibrium is also calculated to point 335. The corresponding image shown at the display 3 is a line or vector 336 connecting all equilibrium points (left panel). This translation scheme to a vector, can be used also for applying to the interaction a direction which can be concluded by the side with more pressure and/or a bigger area and/or order of stepping, etc.

FIG. 17d illustrates an interactive participant 60 touching the interactive surface 1 with both legs 340 and 341 and both hands 342 and 343 (right panel) to form a representation 345 (left panel). The application 11 can also use the areas of each limb for different translations. In this case, both the closed area 345 and each limb's representation is depicted on the display 3 as points 346 to 349 (left panel).

In yet another embodiment of the invention, the interactive surface and display system is used for medical applications 11 and purposes. The application 11 can be used for identifying and tracking a motor condition or behavior, rehabilitation, occupational therapy or training purposes, improving a certain skill or for overcoming a disability regarding a motor, coordinative or cognitive skill. In this embodiment, the trainer is a doctor or therapist setting the system's behavior according to needs, type and level of disability of the disabled person or person in need. Among the skills to be exercised and addressed are stability, orientation, gait, walking, jumping, stretching, movement planning, movement tempo and timing, dual tasks and every day chores, memory, linguistics, attention and learning skills. These skills may be deficient due to different impairments such as orthopedic and/or neurological and/or other causes. Common causes include, but are not limited to, stroke, brain injuries including traumatic brain injury (TBA), diabetes, Parkinson's disease, Alzheimer's disease, muscle-skeleton disorders, arthritis, osteoporosis, attention-deficit/hyperactivity disorder (ADHD), learning difficulties, obesity, amputations, hip, knee, leg and back problems, etc.

Special devices used by disabled people like artificial limbs, wheelchairs, walkers, or walking sticks, can be handled in two ways by the system, or by a combination thereof. The first way is to treat such a device as another object touching the interactive surface 1. The first option is important for an approximate calculation mode where all the areas touching the interactive surface 1 are taken into account, while distinguishing each area and associating it with a person's body part such as right leg or an object part, for example, left wheel in a wheelchair, is neglected.

The second way to consider special devices used by disabled people is to consider such devices as a well-defined objects associated with the interactive participant 60. The second option is useful when distinguishing each body and object part is important. This implementation is achieved by adding distinguishing means and sensors to each part. An automatic or a manual session may be necessary in order to associate each identification unit to the suitable part. This distinguishing process is also important when an assistant is holding or supporting the patient. The assistant is either distinguished by adding to him distinguishing means or by excluding him from the distinguishing means used by the patient and other gear he is using as just mentioned.

A typical usage of this embodiment is an interactive surface 1 with display means embedded into the surface and/or projected onto it, thus guiding or encouraging the interactive participant 60 to advance on the surface and move in a given direction and in a desired manner. For instance, the interactive surface 1 displays a line that the interactive participant 60 is instructed to walk in its direction or, in another case, to skip over it. When the interactive surface 1 has no display means, the interactive participant 60 will view on a display 3 or projected image his legs position and a line. In this case, the interactive participant 60 should move on the interactive surface 1 so that a symbol representing his location will move on the displayed line. This resembles the former mentioned embodiment where the present invention serves as a computer mouse, a joystick, or a computer tablet. The patient can manipulate images, select options and interact with content as presented on the display, by moving on the interactive surface in different directions, changing his balance etc.

In one preferred embodiment of the invention, the system is used for physical training and/or rehabilitation of disabled persons. The system enables the interactive participant 60 (in this case, the user may be a patient, more particularly a disabled person) to manipulate a cursor, image or other images on the separated or combined display 3 according to the manner he moves, touches and locates himself in respect to the interactive surface 1. EMG sensors can be optionally attached to different parts of the user, which update the system, by wireless or wired means with measured data concerning muscle activity, thus enriching this embodiment. Thus the quality of the movement is monitored in depth, enabling the system to derive and calculate more accurately the nature of the movement, and also enabling a therapist to supervise the practice in more detail. The patient is provided with better biofeedback by presenting the data on the display 3 and/or using it in a symbolic fashion in the content being displayed. The patient may be alerted by displaying an image, changing the shape or coloring of an image, or by providing an audio feedback. The patient can thus quickly respond with an improved movement when alerted by the system. Other common biofeedback parameters can be added by using the suitable sensors, for example: heartbeat rate, blood pressure, body temperature at different body parts, conductivity, etc.

The performance of a disabled person is recorded and saved, thus enabling the therapist or doctor to analyze his performance and achievements in order to plan the next set of exercises, and their level of difficulty. Stimulating wireless or wired gear attached to different parts of the user's body can help him perform and improve his movement either by exciting nerves and muscles and/or by providing feedback to the patient regarding what part is touching the interactive surface 1, the way it is touching and the nature of the action performed by the patient. The feedback can serve either as a warning, when the movement is incorrect or not accurate, or as a positive sign when the movement is accurate and correct. The interactive surface can be mounted on a tilt board, other balancing boards, cushioning materials and mattresses, slopes, attached to the wall, used while wearing interactive shoes, interactive shoe sole, soles and/or shoes with embedded sensors, orthopedic shoes, including orthopedic shoes with mushroom-like attachments underneath to exercise balancing and gait. All the above can enrich the exercise by adding more acquired data and changing the environment of practice.

Patients who have problems standing independently can use weight bearing gear which is located around the interactive surface 1 or is positioned in such a manner that it enables such a patient to walk on the interactive surface 1 with no or minimal assistance.

The exercises are formed in many cases as a game in order to motivate the patients to practice and overcome the pain, fears and low motivation they commonly suffer from.

This subsystem is accessed either from the same location or from a remote location. The doctor or therapist can view the patient's performance, review reports of his exercise, plan exercise schedule, and customize different attributes of each exercise suitable to the patient's needs.

Monitoring performance, planning the exercises and customizing their attributes can be done either on location; remotely via a network; or by reading or writing data from a portable memory device that can communicate with the system either locally or remotely.

The remote mode is actually a telemedicine capability making this invention valuable for disabled people who find it difficult to travel far to the rehabilitation clinic, inpatient or outpatient institute and practice their exercises. In addition, it is common that disabled patients need to exercise at home as a supplementary practice or as the only practice when the rehabilitated is at advanced stages or lacks finds for medical services at a medical center. This invention motivates the patient to practice more at home or at the clinic and allows the therapist or doctor to supervise and monitor their practice from a remote location, cutting costs and efforts.

In addition, the patient's practice and the therapist's supervision can be further enriched by adding optional motion tracking means, video capturing means, video streaming means, or any combination thereof. Motion tracking helps training other body parts that are not touching the interactive surface. The therapist can gather more data about the performance of the patient and plan a more focused personalized set of exercises. Video capturing or video streaming allows the therapist, while watching the video, to gather more information on the nature of entire body movement and thus better assess the patient's performance and progress. If the therapist is situated in a remote location, an online video conferencing allows the therapist to send feedback, correct and guide the patient. The therapist or the clinic is also provided with a database with records for each patient, registering the performance reports, exercise plans and the optional video captures. In addition, the therapist can demonstrate to the patients a movement or set of movements and send the demonstration to the patients as a video movie, a drawing, an animation, or any combination thereof. The drawing or animation can be superimposed on the video movie in order to emphasize a certain aspect or point in the exercise and draw the patient's attention to important aspects of the exercise. For instance, the therapist may want to circle or mark different parts of the body, add some text and show, in a simplified manner, the correct or desired path or movement on the interactive surface 1.

Alternatively, instead of showing the video of the therapist himself, an animation of an avatar or person representing the therapist is formed by tracking means situated at the reference space or therapist's space and is shown to the patient on his display 3.

In yet another embodiment of the invention, the interactive surface and display system is used for disabled people for training, improving and aiding them while using different devices for different applications 11, in particular a device like a computer.

In yet another embodiment of the invention, the interactive surface and display system is used as an input device to a computer system, said input device can be configured in different forms according to the requirements of the application 11 or user of the system.

In still another embodiment of the invention, the interactive surface and display system is used for advertisement and presentation applications 11. Users can train using an object or experience interacting with an object by walking, touching, pressing against, hitting, or running on said interactive surface 1 or integrated interactive surface 20.

Although the invention has been described in detail, nevertheless changes and modifications, which do not depart from the teachings of the present invention will be evident to those skilled in the art. Such changes and modifications are deemed to come within the purview of the present invention and the appended claims.

1. An interactive display system, wherein the content displayed on said system is generated based on the actions and movements of one or more users or objects, said system comprising:
i) an interactive surface, resistant to weight and shocks;
ii) means for detecting the position of said one or more users or objects in contact with said interactive surface;
iii) means for detecting the whole area of each said one or more users or objects in contact with said interactive surface; and
iv) means for generating content displayed on a display unit, an integrated display unit, interactive surface, monitor or television set, wherein said content is generated based on the position of one or more said users or objects in contact with said interactive surface and/or the whole area of one or more users or objects in contact with said interactive surface.

2. The interactive display system of claim 1, wherein the position of two or more users or objects in contact with said interactive surface is detected simultaneously.

3. The interactive display system of claim 1, wherein the whole area of two or more users or objects in contact with said interactive surface is detected simultaneously.

4. The interactive display system of claim 1, further comprising means to detect the direction of movement of said one or more users or objects in contact with said interactive surface.

5. The interactive display system of claim 1, further comprising means to measure the extent of pressure applied by each of said users or objects against said interactive surface.

6. The interactive display system of claim 1, wherein said interactive surface is laid on or integrated into the floor.

7. The interactive display system of claim 1, wherein said interactive surface is attached to or integrated into a wall or serves itself as a wall.

8. The interactive display system of claim 1, wherein said interactive surface is a peripheral device of a computer system or a game platform.

9. The interactive display system of claim 1, wherein the display unit or integrated display unit employs at least one display technology selected from the group consisting of: LED, PLED, OLED, Epaper, Plasma, three dimensional display, frontal or rear projection with a standard tube, and frontal or rear laser projection.

10. The interactive display system of claim 1, wherein said generated content is based on additional parameters regarding objects or users in contact with said interactive surface.

11. The interactive surface and display system of claim 10, wherein said additional parameters are sound, voice, speed, weight, temperature, inclination, color, shape, humidity, smell, texture, electric conductivity or magnetic field of said user or object, blood pressure, heart rate, brain waves, EMG readings for said user, or any combination thereof.

12. The interactive display system of any of claims 1 to 12, wherein a position identification unit, responsible for identifying all the contact points of any user or object touching the interactive surface unit, employs at least one proximity or touch input technology selected from the group consisting of:
i) resistive touch-screen technology;
ii) capacitive touch-screen technology;
iii) surface acoustic wave touch-screen technology;
iv) infrared touch-screen technology;
v) a matrix of pressure sensors;
vi) near field imaging touch-screen technology;
vii) a matrix of optical detectors of a visible or invisible range;
viii) a matrix of proximity sensors with magnetic or electrical induction;
ix) a matrix of proximity sensors with magnetic and/or electrical induction, wherein the users or objects carry identifying material with a magnetic and/or RF and/or RFID signature;
x) a matrix of proximity sensors with magnetic or electrical induction wherein users and/or objects carry identifying RFID tags;
xi) a system built with one or more optic sensors and /or cameras with image identification technology
xii) a system built with one or more optic sensors and/or cameras with image identification technology in infra red range;
xiii) a system built with an ultra-sound detector wherein users and/or objects carry ultra-sound emitters;
xiv) a system built with RF identification technology;
xv) a system built with magnetic and/or electric field generators and/or inducers;
xvi) a system built with light sources such as laser, LED, EL, and the like;
xvii) a system built with reflectors;
xviii) a system built with sound generators;
xix) a system built with heat emitters; and
xx) any combination thereof.

13. The interactive display system of claim 12, wherein said image identification technology recognizes unique identifiers or content printed, displayed or projected on said interactive surface.

14. The interactive display system of claim 13, wherein said unique identifiers are integrated into printed, displayed or projected content or engraved in the interactive surface texture and visible through its surface.

15. The interactive display system of claim 12, wherein the position identification unit is integrated into an object, and said object is either worn by the user, held by said user or is independent of said user.

16. An integrated system comprising two or more interactive display systems according to claim 1, wherein contact by a user or an object on one interactive surface affects the content generated and displayed on at least one display unit or integrated display unit.

17. The integrated system according to claim 16, wherein at least two interactive display systems are within close proximity of each other and are connected by wired or wireless means.

18. The integrated system according to claim 16, wherein all interactive surface and display units combine to act as a single larger screen, each said individual display unit or integrated display unit displaying one portion of a single source of content generated.

19. The integrated system according to claim 18, wherein each said individual display unit or integrated display units displays an entire source of content generated.

20. The integrated system according to claim 16, wherein at least two interactive surface and display systems are not within close proximity of each other and are connected by an external network.

21. The integrated system according to claim 20, wherein said external network is the Internet.

22. An interactive display system according to claim 1 for entertainment purposes, wherein said user plays a game by stepping on, walking on, running on, kicking, punching, touching, hitting, or pressing against said interactive surface.

23. An integrated system according to claim 16, for entertainment purposes, wherein said user plays a game by stepping on, walking on, running on, kicking, punching, touching, hitting, or pressing against said interactive surface.

24. An interactive display system according to claim 22 or 23, wherein two or more users play with or compete against each other.

25. An interactive display system according to claim 22 or 23, wherein users use an object to interact with the game.

26. An interactive display system according to claim 25, wherein said object is selected from the group consisting of a ball, a racquet, a bat, a toy, any vehicle including a remote controlled vehicle, and transportation aid using one or more wheels.

27. An interactive display system according to claim 1 for medical applications, wherein a medical application is used for identifying and/or tracking a motor condition, or in a rehabilitation or training activity for coordination, motor or cognitive skills.

28. An interactive display system according to claim 27 for rehabilitation purposes, wherein devices used by disabled persons include an orthopedic shoe, a sole, a walker, a walking stick, a wheelchair, a crutch, a support, a belt, a band, a pad, a prosthetic or artificial body part attached or implanted in the patient, or any other orthopedic or rehabilitation equipment.

29. An interactive display system according to claim 1 for advertisement and presentation applications, wherein users can train using an object or experience interacting with an object by walking, touching, pressing against, hitting, or running on said interactive surface.

30. An interactive display system according to claim 1, wherein the system can deduce the path of movement of a user or object in the air, after touching point A in the interactive surface and until touching point B in the interactive surface.

31. An interactive display system according to claim 1, wherein the system acts as computer mouse, joystick or computer tablet in order to manipulate an image, graphics or any content, and said action is achieved by translating the contact points and areas on the interactive surface and translating deduced movements performed by said user.

32. An interactive display system according to claim 1, wherein said system is wearable.

33. An interactive display system according to 32, wherein said wearable system is integrated into a shoe, a shoe attachment, an insole or a device wrapping a shoe.

34. An interactive display system according to claim 1, wherein said system is used as a tablet, joystick or electronic mouse for operating and controlling a computer or any other device.

35. An interactive display system according to claim 1, wherein said system is used for physical training and/or rehabilitation.

36. An interactive display system according to 35, wherein a trainer is located in a remote location from the user performing an exercise, and said trainer can control the application, review performance reports and feed-back the user or users from the remote location.

37. A method for displaying interactive content generated based on the actions and movements of one or more users or objects, the method comprising the steps of:
i) detecting the position of said one or more users or objects in contact with one or more interactive surface units;
ii) detecting the entire area of said one or more users or objects in contact with said one or more interactive surface units; and
iii) generating content displayed on a display unit, integrated display unit, monitor or TV set, wherein said content is generated based on the position of one or more users or objects in contact with said one or more interactive surface and/or the entire area of one or more users or objects in contact with said one or more interactive surface.
